(19) United States
(12) Patent Application Publication
(10) Pub. No.: US 2025/0323755 A1
(43) Pub. Date: Oct. 16, 2025

(54) DISTRIBUTED NETWORK CODING WITH COMPLEMENTARY NETWORK CODING DEVICES

(71) Applicant: QUALCOMM INCORPORATED, San Diego, CA (US)

(72) Inventors: Guangyi Liu, Shanghai (CN); Gabi Sarkis, San Diego, CA (US); Shuanshuan Wu, San Diego, CA (US); Kapil Gulati, Belle Mead, NJ (US)

(21) Appl. No.: 18/869,177

(22) PCT Filed: Aug. 5, 2022
(86) PCT No.: PCT/CN2022/110503

§ 371 Date: Nov. 25, 2024

(51) Int. Cl. H04L 1/00; H04L 1/08

(52) U.S. Cl. CPC H04L 1/0076; H04L 1/08

(57) ABSTRACT

Methods, systems, and devices for wireless communications are described. A network coding device may assign scores to network coding packets to determine which of the network coding packets to transmit. The network coding packets may include data, information, or transport blocks from different subsets of packets, and the network coding device may transmit a first network coding packet based on a score of the first network coding packet satisfying a threshold. In some examples, a first user equipment (UE) may receive the first network coding packet and may determine that the first network coding packet includes data, information, or transport blocks from a first packet originally transmitted by the first UE. The first UE may skip retransmission of the first packet based on receiving the first network coding packet, and the first UE may monitor for feedback for the first packet despite skipping retransmission of the first packet.

### CROSS REFERENCE

The present Application is a 371 national stage filing of International PCT Application No. PCT/CN2022/110503 by Liu et al. entitled “DISTRIBUTED NETWORK CODING WITH COMPLEMENTARY NETWORK CODING DEVICES,” filed Aug. 5, 2022, which is assigned to the assignee hereof, and which is expressly incorporated by reference in its entirety herein.

### TECHNICAL FIELD

The following relates to wireless communications, including distributed network coding with complementary network coding devices.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some wireless communications systems may support retransmissions of a packet by a transmitting device (for example, a UE, a network entity, a road-side unit (RSU)) to improve the likelihood that the packet is successfully received by one or more receiving devices. In such cases, in examples in which even one of the one or more receiving devices fails to receive the packet, the transmitting device may be triggered to retransmit the packet to each of the one or more receiving devices. As a result, an overhead for retransmissions in the wireless communications system may be high.

To minimize the overhead of retransmissions, a wireless communications system may support network coding. Network coding may refer to encoding or aggregating data, information, or transport blocks from multiple packets to generate a single packet for transmission. The single packet may be referred to as a network coding packet, and, because the network coding packet may include data, information, or transport blocks from multiple packets, the network coding packet may be a retransmission of the multiple packets. The network coding packet may replace multiple retransmissions of multiple packets with a single retransmission of the multiple packets, resulting in reduced overhead in a wireless communications system.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications at a network coding device. The method includes receiving a set of multiple source packets from one or more first user equipment (UEs), assigning a score to a first network coding packet of a set of multiple network coding packets, each network coding packet of the set of multiple network coding packets including one or more transport blocks from a different respective subset of source packets of the set of multiple source packets, and transmitting, to one or more second UEs, the first network coding packet based on the score satisfying a scoring threshold.

Another innovative aspect of the subject matter described in this disclosure can be implemented in an apparatus for wireless communications at a network coding device. The apparatus may include a processor, memory coupled with the processor, and instructions stored in the memory. The instructions may be executable by the processor to cause the apparatus to receive a set of multiple source packets from one or more first user equipment (UEs), assign a score to a first network coding packet of a set of multiple network coding packets, each network coding packet of the set of multiple network coding packets including one or more transport blocks from a different respective subset of source packets of the set of multiple source packets, and transmit, to one or more second UEs, the first network coding packet based on the score satisfying a scoring threshold.

Another innovative aspect of the subject matter described in this disclosure can be implemented in an apparatus for wireless communications at a network coding device. The apparatus may include means for receiving a set of multiple source packets from one or more first user equipment (UEs), means for assigning a score to a first network coding packet of a set of multiple network coding packets, each network coding packet of the set of multiple network coding packets including one or more transport blocks from a different respective subset of source packets of the set of multiple source packets, and means for transmitting, to one or more second UEs, the first network coding packet based on the score satisfying a scoring threshold.

Another innovative aspect of the subject matter described in this disclosure can be implemented in a non-transitory computer-readable medium storing code for wireless communications at a network coding device. The code may include instructions executable by a processor to receive a set of multiple source packets from one or more first user equipment (UEs), assign a score to a first network coding packet of a set of multiple network coding packets, each network coding packet of the set of multiple network coding packets including one or more transport blocks from a different respective subset of source packets of the set of multiple source packets, and transmit, to one or more second UEs, the first network coding packet based on the score satisfying a scoring threshold.

Another innovative aspect of the subject matter described in this disclosure can be implemented in a method for wireless communications at a first UE. The method includes transmitting a first packet to at least a second UE, receiving a first network coding packet from a network coding device, the first network coding packet including one or more transport blocks from the first packet based on the second UE failing to successfully receive the first packet, skipping retransmission of the first packet based on receiving the first network coding packet from the network coding device, and monitoring for acknowledgment or negative acknowledgment feedback for the first packet despite skipping retransmission of the first packet.

Another innovative aspect of the subject matter described in this disclosure can be implemented in an apparatus for wireless communications at a first UE. The apparatus may include a processor, memory coupled with the processor, and instructions stored in the memory. The instructions may be executable by the processor to cause the apparatus to transmit a first packet to at least a second UE, receive a first network coding packet from a network coding device, the first network coding packet including one or more transport blocks from the first packet based on the second UE failing to successfully receive the first packet, skip retransmission of the first packet based on receiving the first network coding packet from the network coding device, and monitor for acknowledgment or negative acknowledgment feedback for the first packet despite skipping retransmission of the first packet.

Another innovative aspect of the subject matter described in this disclosure can be implemented in an apparatus for wireless communications at a first UE. The apparatus may include means for transmitting a first packet to at least a second UE, means for receiving a first network coding packet from a network coding device, the first network coding packet including one or more transport blocks from the first packet based on the second UE failing to successfully receive the first packet, means for skipping retransmission of the first packet based on receiving the first network coding packet from the network coding device, and means for monitoring for acknowledgment or negative acknowledgment feedback for the first packet despite skipping retransmission of the first packet.

Another innovative aspect of the subject matter described in this disclosure can be implemented in a non-transitory computer-readable medium storing code for wireless communications at a first UE. The code may include instructions executable by a processor to transmit a first packet to at least a second UE, receive a first network coding packet from a network coding device, the first network coding packet including one or more transport blocks from the first packet based on the second UE failing to successfully receive the first packet, skip retransmission of the first packet based on receiving the first network coding packet from the network coding device, and monitor for acknowledgment or negative acknowledgment feedback for the first packet despite skipping retransmission of the first packet.

### BRIEF DESCRIPTION OF THE DRAWINGS

FIG. 1 illustrates an example of a wireless communications system that supports distributed network coding with complementary network coding devices in accordance with one or more aspects of the present disclosure.

FIG. 2 illustrates an example of a network coding retransmission in accordance with one or more aspects of the present disclosure.

FIG. 3 illustrates an example of a process flow in accordance with one or more aspects of the present disclosure.

FIG. 4 illustrates an example of a wireless communications system that supports distributed network coding with complementary network coding devices in accordance with one or more aspects of the present disclosure.

FIG. 5 illustrates an example of a process flow that supports distributed network coding with complementary network coding devices in accordance with one or more aspects of the present disclosure.

FIGS. 6 and 7 show block diagrams of devices that support distributed network coding with complementary network coding devices in accordance with one or more aspects of the present disclosure.

FIG. 8 shows a block diagram of a communications manager that supports distributed network coding with complementary network coding devices in accordance with one or more aspects of the present disclosure.

FIG. 9 shows a diagram of a system including a device that supports distributed network coding with complementary network coding devices in accordance with one or more aspects of the present disclosure.

FIGS. 10 and 11 show block diagrams of devices that support distributed network coding with complementary network coding devices in accordance with one or more aspects of the present disclosure.

FIG. 12 shows a block diagram of a communications manager that supports distributed network coding with complementary network coding devices in accordance with one or more aspects of the present disclosure.

FIG. 13 shows a diagram of a system including a device that supports distributed network coding with complementary network coding devices in accordance with one or more aspects of the present disclosure.

FIGS. 14 and 15 show flowcharts illustrating methods that support distributed network coding with complementary network coding devices in accordance with one or more aspects of the present disclosure.

### DETAILED DESCRIPTION

Some wireless communications systems may support network coding to minimize the overhead of retransmitting packets. A network coding device may receive source packets from one or more user equipment (UEs) and may aggregate data, information, or transport blocks from the source packets to generate a network coding packet for transmission. In some cases, a network coding device may take over retransmission of a source packet from a UE after an initial transmission of the source packet from the UE. Taking over retransmission of the source packet may refer to being fully responsible for retransmitting the source packet, such that the UE may avoid retransmitting the source packet and avoid monitoring for feedback for the source packet. In some implementations, however, it may be appropriate for a network coding device to assist in retransmitting a source packet without taking over retransmission of the source packet. Such a network coding device may be referred to as a complementary network coding device. Because a complementary network coding device may avoid taking over retransmission of a source packet originally transmitted by a UE, the UE may continue to monitor for feedback for the source packet. A network including complementary network coding devices may support distributed network coding, where various wireless devices may be dynamically configured or spun up to assist with retransmission in a network. Distributed network coding with complementary network coding devices may improve the flexibility of network coding because a quantity of network coding devices assisting with retransmissions may be adapted based on dynamic conditions.

Various aspects generally relate to network coding, and more specifically, to distributed network coding with complementary network coding devices. A network coding device may receive multiple source packets and may assign respective scores to network coding packets each including data, information, or transport blocks from a different respective subset of the source packets. A score of a network coding packet may be associated with a likelihood that data, information, or transport blocks from a subset of source packets included in the network coding packet will be successfully received by one or more UEs. The network coding device may assign scores satisfying a scoring threshold to a subset of network coding packets, and the network coding device may select a network coding packet to transmit from the subset of network coding packets. The network coding device may then transmit the selected network coding packet to one or more UEs. In some examples, a UE may receive the network coding packet and may determine that the network coding packet includes data, information, or a transport block from a source packet originally transmitted by the UE. Based on the determination, the UE may, in some examples, determine that at least one UE failed to receive the packet, and it may be appropriate for the packet to be retransmitted. Nevertheless, the UE may skip retransmission of the packet based on receiving the network coding packet (e.g., since the network coding device already retransmitted the packet), but the UE may still monitor for feedback for the packet despite skipping retransmission of the packet.

Particular aspects of the subject matter described in this disclosure may be implemented to realize one or more of the following potential advantages, among others. The techniques employed by the described communication devices may reduce signaling overhead associated with data transmissions based on limiting (for example, skipping) retransmissions of packets. In some implementations, the operations performed by the described communication devices may enhance reliability and prevent wasteful transmissions of some network coding packets because the communication devices (for example, network coding devices) transmit only those network coding packets with scores satisfying a scoring threshold. In some implementations, the operations performed by a described communications device to continue to monitor for feedback for a source packet, while a network coding device assists with retransmitting the source packet, may provide the network coding device with flexibility to assist with retransmitting the source packet without additional signaling to coordinate retransmission of the source packet by the network coding device.

Aspects of the disclosure are initially described in the context of wireless communications systems. Aspects of the disclosure are further illustrated by and described with reference to apparatus diagrams, system diagrams, and flowcharts that relate to distributed network coding with complementary network coding devices.

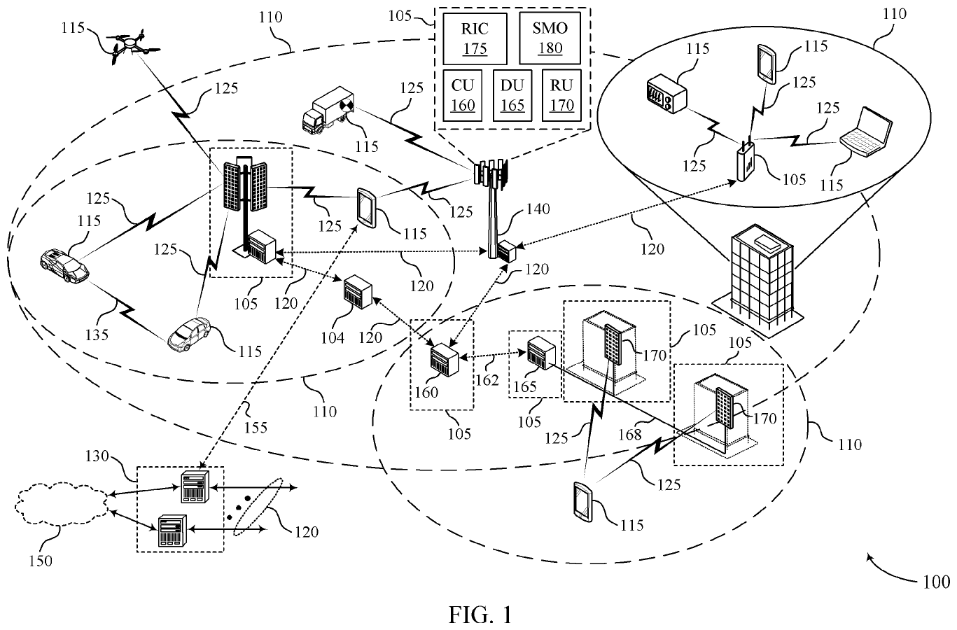

FIG. 1 illustrates an example of a wireless communications system 100 that supports distributed network coding with complementary network coding devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (for example, a radio frequency (RF) access link). For example, a network entity 105 may support a coverage area 110 (for example, a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (for example, in accordance with an S1, N2, N3, or other interface protocol). In some examples, network entities 105 may communicate with one another via a backhaul communication link 120 (for example, in accordance with an X2, Xn, or other interface protocol) either directly (for example, directly between network entities 105) or indirectly (for example, via a core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication links 120, midhaul communication links 162, or fronthaul communication links 168 may be or include one or more wired links (for example, an electrical link, an optical fiber link), one or more wireless links (for example, a radio link, a wireless optical link), among other examples or various combinations thereof. A UE 115 may communicate with the core network 130 via a communication link 155.

One or more of the network entities 105 described herein may include or may be referred to as a base station 140 (for example, a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within a single network entity 105 (for example, a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU) 160, a distributed unit (DU) 165, a radio unit (RU) 170, a RAN Intelligent Controller (RIC) 175 (for example, a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 170 is flexible and may support different functionalities depending on which functions (for example, network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3 (L3), layer 2 (L2)) functionality and signaling (for example, Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or more RUs 170). In some cases, a functional split between a CU 160 and a DU 165, or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (for example, F1, F1-c, F1-u), and a DU 165 may be connected to one or more RUs 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities 105 that are in communication via such communication links.

In wireless communications systems (for example, wireless communications system 100), infrastructure and spectral resources for radio access may support wireless backhaul link capabilities to supplement wired backhaul connections, providing an IAB network architecture (for example, to a core network 130). In some cases, in an IAB network, one or more network entities 105 (for example, IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (for example, a donor base station 140). The one or more donor network entities 105 (for example, IAB donors) may be in communication with one or more additional network entities 105 (for example, IAB nodes 104) via supported access and backhaul links (for example, backhaul communication links 120). IAB nodes 104 may include an IAB mobile termination (IAB-MT) controlled (for example, scheduled) by DUs 165 of a coupled IAB donor. An IAB-MT may include an independent set of antennas for relay of communications with UEs 115, or may share the same antennas (for example, of an RU 170) of an IAB node 104 used for access via the DU 165 of the IAB node 104 (for example, referred to as virtual IAB-MT (vIAB-MT)). In some examples, the IAB nodes 104 may include DUs 165 that support communication links with additional entities (for example, IAB nodes 104, UEs 115) within the relay chain or configuration of the access network (for example, downstream). In such cases, one or more components of the disaggregated RAN architecture (for example, one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support distributed network coding with complementary network coding devices as described herein. For example, some operations described as being performed by a UE 115 or a network entity 105 (for example, a base station 140) may additionally, or alternatively, be performed by one or more components of the disaggregated RAN architecture (for example, IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (for example, an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities 105).

In some examples, such as in a carrier aggregation configuration, a carrier may also have acquisition signaling or control signaling that coordinates operations for other carriers. A carrier may be associated with a frequency channel (for example, an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (for example, of the same or a different radio access technology).

The communication links 125 shown in the wireless communications system 100 may include downlink transmissions (for example, forward link transmissions) from a network entity 105 to a UE 115 (for example, in a physical downlink shared channel (PDSCH) or a physical downlink control channel (PDCCH)), uplink transmissions (for example, return link transmissions) from a UE 115 to a network entity 105 (for example, in a physical uplink shared channel (PUSCH) or a physical uplink control channel (PUCCH)), or both, among other configurations of transmissions. Carriers may carry downlink or uplink communications (for example, in an FDD mode) or may be configured to carry downlink and uplink communications (for example, in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (for example, 1.4, 3, 5, 10, 15, 20, 40, or 80 megahertz (MHz)). Devices of the wireless communications system 100 (for example, the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (for example, a sub-band, a BWP) or all of a carrier bandwidth.

Signal waveforms transmitted via a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both), such that a relatively higher quantity of resource elements (for example, in a transmission duration) and a relatively higher order of a modulation scheme may correspond to a relatively higher rate of communication. A wireless communications resource may refer to a combination of an RF spectrum resource, a time resource, and a spatial resource (for example, a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively-numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, a quantity of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (for example, using a carrier) and may be associated with an identifier for distinguishing neighboring cells (for example, a physical cell identifier (PCID), a virtual cell identifier (VCID), or others). In some examples, a cell also may refer to a coverage area 110 or a portion of a coverage area 110 (for example, a sector) over which the logical communication entity operates. Such cells may range from smaller areas (for example, a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (for example, several kilometers in radius) and may allow unrestricted access by the UEs 115 with service subscriptions with the network provider supporting the macro cell. A small cell may be associated with a lower-powered network entity 105 (for example, a lower-powered base station 140), as compared with a macro cell, and a small cell may operate using the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (for example, MTC, narrow band IoT (NB-IoT), enhanced mobile broadband (eMBB)) that may provide access for different types of devices.

In some examples, a network entity 105 (for example, a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a network entity 105 (for example, a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (for example, according to narrow band communications), or a combination of these techniques. For example, some UEs 115 may be configured for operation using a narrow band protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (for example, in accordance with a peer-to-peer (P2P), D2D, or sidelink protocol). In some examples, one or more UEs 115 of a group that are performing D2D communications may be within the coverage area 110 of a network entity 105 (for example, a base station 140, an RU 170), which may support aspects of such D2D communications being configured by (for example, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (for example, UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, network entities 105, base stations 140, RUs 170) using vehicle-to-network (V2N) communications, or with both.

In some cases, a network entity 105 facilitates the scheduling of resources for sidelink communications. In other cases, sidelink communications are carried out between UEs 115 without the involvement of a network entity 105. According to some aspects, sidelink communications may include discovery expression transmissions on a physical sidelink discovery channel (PSDCH) (for example, to allow proximal devices to discover each other's presence). According to some aspects, sidelink communications may include control information transmissions on a physical sidelink control channel (PSCCH). According to some aspects, sidelink communications may include data transmissions on a physical sidelink shared channel (PSSCH). According to some aspects, sidelink communications may include feedback transmissions on a physical sidelink feedback channel (PSFCH).

According to some aspects, sidelink communications may include LTE V2X or cellular V2X (C-V2X), NR V2X or C-V2X, and NR sidelink. In NR-V2X, two modes may be defined for resource allocation. In a first mode (for example, mode-1), a network entity 105 may determine the resources used by a sidelink transmit UE 115 for a sidelink transmission (for example, on a PSCCH, PSSCH, or PSFCH). In a second mode (for example, mode-2), a sidelink transmit UE (for example, not the network entity 105) may determine the resources to use for sidelink communications. Sensing and resource selection and reselection related procedures may be supported for the second mode. The sensing procedure may be defined as decoding the sidelink control information (SCI) from other UEs 115 and/or performing sidelink measurements. Decoding SCIs in the sensing procedure may provide at least some information on sidelink resources indicated by the UE 115 transmitting the SCI.

NR-V2X may support an initial transmission of a transport block from a sidelink UE 115 without reservation, based on sensing and a resource selection procedure. NR-V2X may support the reservation of a sidelink resource for an initial transmission of a transport block at least by an SCI associated with a different transport block, based on sensing and a resource selection procedure. In some cases, NR-V2X mode-2 may support resource reservation for feedback-based PSSCH retransmissions by signaling associated with a prior transmission of the same transport block (for example, where the feedback may impact subsequent sensing and resource selection procedures). From the perspective of a transmit sidelink UE 115, the use of hybrid automatic repeat request (HARQ) feedback for the release of unused resources may be supported (for example, with no additional signaling being defined for the purpose of the release of unused resources by the transmit UE 115). Additionally, in mode-2, the SCI payload may indicate the sub-channels and slots used by a UE 115 or reserved by a UE 115 for PSSCH transmissions or retransmissions.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (for example, less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (for example, from 30 GHz to 300 GHz), also known as the millimeter band. In some examples, the wireless communications system 100 may support millimeter wave (mmW) communications between the UEs 115 and the network entities 105 (for example, base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (for example, LAA). Operations using unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (for example, a communication link 125, a D2D communication link 135). HARQ feedback may include an acknowledgment (ACK) indicating that a device successfully received and decoded data, and HARQ feedback may include a negative acknowledgment (NACK) indicating that a device failed to receive or decode data. HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The implementation of a framework (for example, a HARQ framework) for supporting retransmissions of packets may improve the reliability of communications. However, as the number of communicating devices in the wireless communications system 100 increases, the overhead of retransmissions may be relatively high. To minimize the overhead of retransmissions, the wireless communications system 100 may support network coding. Network coding may refer to encoding or aggregating data, information, or transport blocks from multiple packets to generate a single packet for transmission. The single packet may be referred to as a network coding packet, and, because the network coding packet may include data, information, or transport blocks from multiple packets, the network coding packet may be a retransmission of the multiple packets. The network coding packet may replace multiple retransmissions of multiple packets with a single retransmission of the multiple packets, resulting in reduced overhead in the wireless communications system 100.

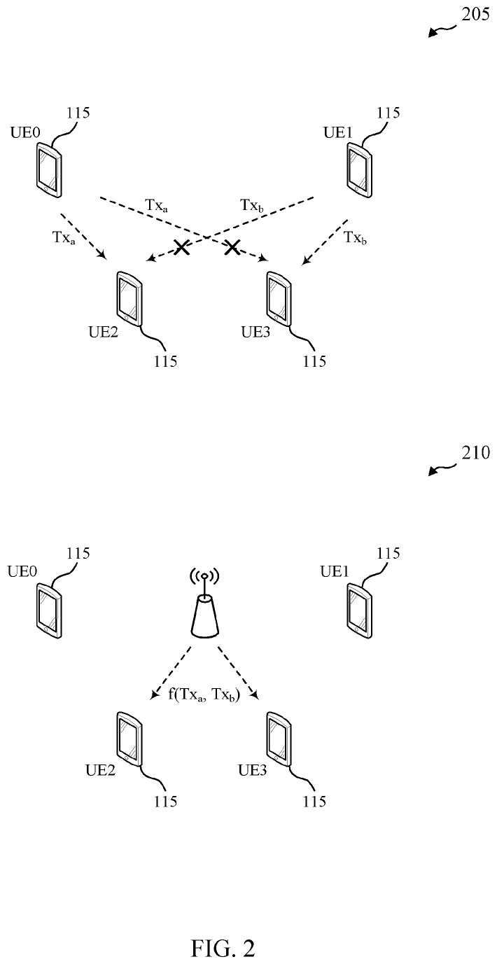

FIG. 2 illustrates an example of a network coding retransmission in accordance with one or more aspects of the present disclosure. Network coding may be used to increase system capacity and improve resource utilization. The increased system capacity and improved resource utilization may be achieved by reducing the number of retransmissions in a system while maintaining a performance metric (for example, a quantity of successfully received packets). Network coding may also enable an increase in the number of UEs 115 or an increase in traffic for each UE 115. In a first instance 205, one or more source UEs 115 (for example, UE0 and UE1) may transmit packets (for example, Txₐ and Tx_{b}) to one or more target UEs 115 (for example, UE2 and UE3). Then, in a second instance 210, a network coding device may retransmit the packets to the one or more target UEs 115. That is, after an initial or original transmission, retransmissions by a source transmitter may be replaced by a retransmission by a network coding device. The retransmission by the network coding device may be a function of the original transmissions from the one or more source UEs 115 (for example, ƒ(Txₐ, Tx_{b})). The network coding device may be a network entity 105, a road-side unit (RSU), or a UE 115.

In some examples of network coding, single parity check codes may correct one erasure of a packet. For instance, an input of [a, b, c] may be encoded to [a, b, c, a⊕b⊕c] and then transmitted, in which a, b, and c each correspond to different packets. A receiving device may then recover one erasure from the network coded transmission. In particular, in examples in which the received vector is [a, ?, c, a⊕b⊕c], the erased element (for example, b) may be recovered by summing the other elements (for example, a⊕c⊕(a⊕b⊕c)=b). Network coding may be viewed as a linear system (for example, over a Galois field) with three variables and four linearly independent constraints in accordance with Equation 1 below. Any three constraints (for example, one erasure) may be sufficient to find the three variables. A single network coded transmission or encoded sequence from a network coding device may replace multiple retransmissions or encoded sequences from multiple wireless devices.

$$[ \begin{matrix}1 & 0 & 0 \\ 0 & 1 & 0 \\ 0 & 0 & 1 \\ 1 & 1 & 1\end{matrix} ] \cdot {[ a b c ]}^{T} = {[ a b c a ⊕ b ⊕ c ]}^{T} \qquad ( 1 )$$

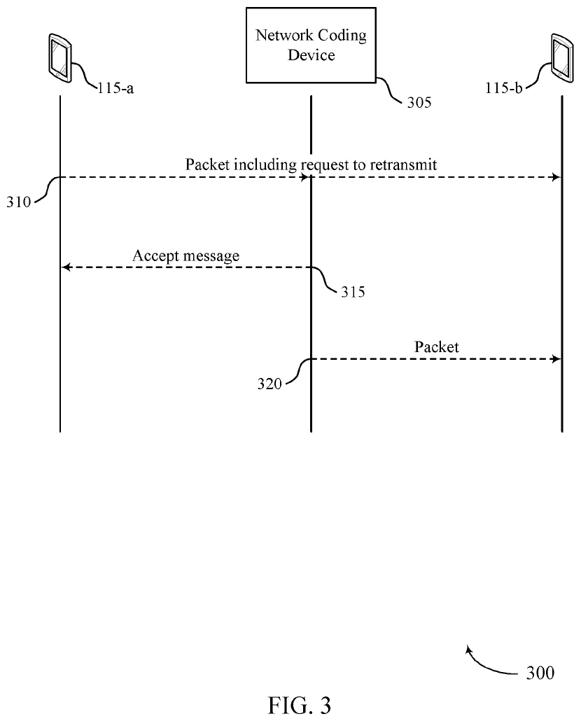

FIG. 3 illustrates an example of a process flow 300 in accordance with one or more aspects of the present disclosure. The process flow 300 may be an example protocol using network coding for sidelink communication (for example, a centralized network coding protocol). The process flow 300 includes a UE 115-a and a UE 115-b, which may be examples of UEs 115 described with reference to FIGS. 1 and 2. The process flow 300 also includes a network coding device 305, which may be an example of a network coding device described with reference to FIGS. 1 and 2. The network coding device 305 may be an RSU, relay, UE 115, or a network entity 105.

At 310, the UE 115-a (for example, a source UE) may transmit a first packet (for example, one or more transport blocks) with a network coding request flag. The network coding device 305 may receive the first packet with the network coding request flag from the UE 115-a, and, at 315, the network coding device 305 may transmit an accept message to the UE 115-a to accept the request (for example, the request to retransmit the first packet). That is, the network coding device 305 may send a message to accept the request to include data, information, or transport blocks from the first packet in a network coding packet (for example, as part of a network coded transmission). At 320, the network coding device 305 may then transmit the network coding packet to the UE 115-b including data, information, or transport blocks from the first packet.

The techniques described with reference to FIG. 3 may enable the network coding device 305 to take over retransmission of the first packet (for example, become fully responsible for the retransmission), and the UE 115-a may avoid retransmitting the first packet or monitoring for ACK or NACK feedback for the first packet from the UE 115-b. In some implementations, however, it may be appropriate for a network coding device to assist in retransmitting a packet without taking over retransmission of the packet (in other words, without becoming fully responsible for the retransmission). Such a network coding device may be referred to as a complementary network coding device. That is, a complementary network coding device may be a network coding device used to complement original transmitting devices and optimize retransmissions of a packet, while the original transmitting devices may still be able to retransmit the packet and may continue to monitor for ACK or NACK feedback for the packet.

The wireless communications system 100 may support a network design including complementary network coding devices. Such a network design may support distributed network coding. Distributed network coding may refer to network coding at various wireless devices which may be dynamically configured or spun up to assist with retransmission in a network. Distributed network coding may differ from network coding using preconfigured or fixed network coding devices. Distributed network coding may be used in examples in which it is too complex for network coding devices to take over retransmissions. It may be too complex for network coding devices to take over retransmissions in examples in which there are no reserved network coding resources or in examples in which network coding devices are unable to monitor transmissions from each other (for example, due to a limited buffer size). In some examples of distributed network coding, a network entity 105 may not manage network coding devices and may not be able to determine which devices are network coding devices. Instead, the network coding devices may independently determine whether to assist with retransmitting packets.

Distributed network coding with complementary network coding devices may improve the flexibility of network coding in the wireless communications system 100. For instance, the wireless communications system 100 may adapt a quantity of network coding devices assisting with retransmissions based on dynamic conditions (for example, changing traffic patterns and channel conditions), and the limitations of each network coding device (for example, a buffer size, power, or location) may be less consequential. In some implementations, however, this additional flexibility may bring new challenges. For instance, it may be challenging for network coding devices to determine packets to retransmit without repeatedly retransmitting the same packets. Further, techniques at a wireless device (for example, an original transmitter) for monitoring for feedback for a packet in examples in which the packet is retransmitted by a network coding device may be underdeveloped or undefined.

The wireless communications system 100 may support efficient techniques for distributed network coding with complementary network coding devices. A network coding device may assign scores to network coding packets to determine which of the network coding packets to transmit. The network coding packets may include data, information, or transport blocks from different subsets of packets, and the network coding device may transmit a first network coding packet based on a score of the first network coding packet satisfying a threshold. In some examples, a first UE may receive the first network coding packet and may determine that the first network coding packet includes data, information, or transport blocks from a first packet originally transmitted by the first UE. The first UE may skip retransmission of the first packet based on receiving the first network coding packet, and the first UE may monitor for feedback for the first packet despite skipping retransmission of the first packet.

Because a network coding device may monitor for packets and select a subset of the packets to retransmit without additional signaling exchanges with UEs 115 or other network coding devices (for example, request messages and accept messages), the overhead of network coding may be minimized. Further, because a network coding device may be configured to transmit a first network coding packet in examples in which a score of the first network coding packet satisfies a threshold, less network coding packets may be transmitted (for example, reducing an impact on UEs 115 that may be unable to decode network coding packets). For instance, a network coding device may not transmit a network coding packet including data, information, or transport blocks from a packet unless the network coding device has a better reach than an original transmitter of the packet or unless there are more advantages than disadvantages associated with transmitting the network coding packet. As a result, less physical resources, power, and processing resources may be wasted on generating and transmitting unnecessary network coding packets (for example, network coding packets containing a single transport block).

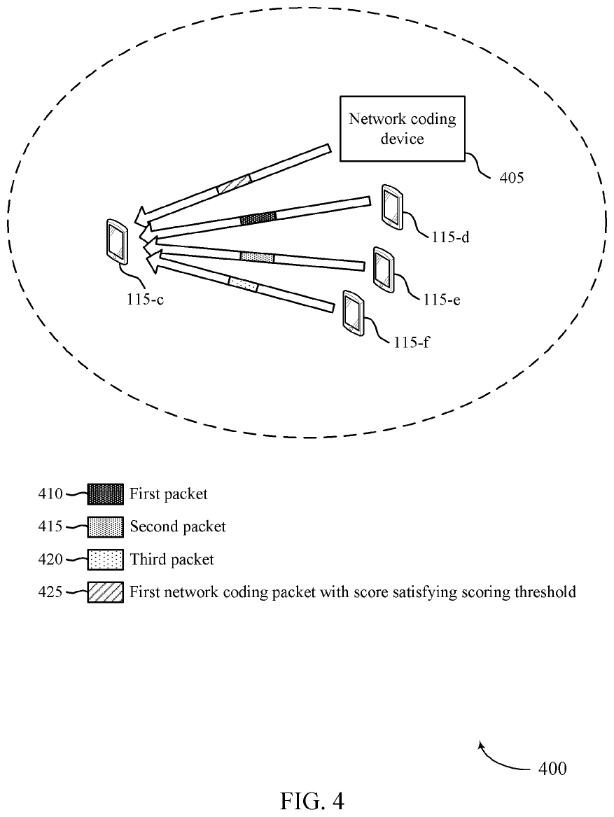

FIG. 4 illustrates an example of a wireless communications system 400 that supports distributed network coding with complementary network coding devices in accordance with one or more aspects of the present disclosure. The wireless communications system 400 includes a UE 115-c, a UE 115-d, a UE 115-e, and a UE 115-f, which may be examples of UEs 115 described with reference to FIGS. 1-3. The wireless communications system 400 also includes a network coding device 405, which may be an example of a network coding device described with reference to FIGS. 1-3. The wireless communications system 400 may implement aspects of the wireless communications system 100. For instance, the wireless communications system 400 may support efficient techniques for distributed network coding with complementary network coding devices.

A UE 115-d, a UE 115-e, and a UE 115-f may transmit a first packet 410, a second packet 415, and a third packet 420, respectively, to a UE 115-c. The UE 115-c may fail to successfully receive or decode the first packet 410, the second packet 415, and the third packet 420, and the UE 115-c may transmit NACKs indicating that the UE 115-c failed to successfully receive these packets. The network coding device 405 may receive the first packet 410, the second packet 415, and the third packet 420 from the UE 115-d the UE 115-e, and the UE 115-f respectively, and the network coding device 405 may determine that the UE 115-c failed to receive the first packet 410, the second packet 415, and the third packet 420. For instance, the network coding device 405 may receive the NACKs indicating that the UE 115-c failed to successfully receive these packets, and the network coding device 405 may buffer the first packet 410, second packet 415, and the third packet 420 (for example, each network coding device may buffer transport blocks that are not received by all intended recipients).

After determining that the UE 115-c failed to receive the first packet 410, the second packet 415, and the third packet 420, the network coding device 405 may determine to retransmit one or more of these packets to the UE 115-c. Retransmitting packets may refer to transmitting data, information, or transport blocks from the packets in a network coding packet. The network coding device 405 may compute potential network coding packets including different subsets of the first packet 410, the second packet 415, the third packet 420, and other packets, and the network coding device may score the network coding packets. The network coding device 405 may then transmit or may be configured to transmit only those network coding packets whose scores satisfy a scoring threshold (for example, scores larger than a scoring threshold). The scoring threshold may be preconfigured at the network coding device 405 (for example, preloaded on the network coding device 405 without any signaling from a network entity 105), or a network entity 105 may signal the scoring threshold to the network coding device 405. The scoring threshold may depend on a network condition in an area (for example, an area or region including the UE 115-c the UE 115-d the UE 115-e, the UE 115-f, or the network coding device 405).

The network coding device 405 may support one or more techniques for scoring network coding packets. In some examples, a scoring metric may correspond to an expected quantity of NACK-to-ACK flips. A NACK-to-ACK flip may be a successful reception of a packet retransmitted in a network coding packet by the network coding device 405. The network coding device 405 may monitor for ACK or NACK feedback from UEs 115 to compute an expected quantity of NACK-to-ACK flips for a network coding packet. The network coding device 405 may expect a NACK-to-ACK flip for a packet retransmitted to the UE 115-c based on the UE 115-c successfully receiving a threshold quantity or percentage of packets from the network coding device 405 in the past. Alternatively, the network coding device 405 may not expect a NACK-to-ACK flip for a packet retransmitted to another UE 115 based on the other UE 115 failing to successfully receive a threshold quantity or percentage of packets from the network coding device 405 in the past.

In an example, the network coding device 405 may assign a score of three to a first network coding packet including data, information, or transport blocks from three packets intended for the UE 115-c because the network coding device 405 may expect three NACK-to-ACK flips from transmitting the first network coding packet. Alternatively, the network coding device 405 may assign a score of two to a second network coding packet including data, information, or transport blocks from two packets intended for the UE 115-c and one packet intended for the other UE 115 because the network coding device 405 may expect two NACK-to-ACK flips from transmitting the second network coding packet. In some examples, the network coding device 405 may retransmit a packet in a network coding packet up to a maximum quantity of times. A maximum quantity of transmissions for a packet or a transport block by the network coding device 405 may be preconfigured, or a network entity 105 may signal the maximum quantity of transmissions for the packet to the network coding device 405.

After the network coding device 405 computes the scores of multiple network coding packets (for example, based on a combination or subset of packets in each network coding packet), the network coding device 405 may select a first network coding packet 425 for transmission from the multiple network coding packets. For instance, the network coding device 405 may select the first network coding packet 425 from a subset of network coding packets with scores satisfying a scoring threshold. In some examples, the network coding device 405 may randomly select the first network coding packet 425 for transmission from the subset of network coding packets with scores satisfying the scoring threshold. Random selection of a network coding packet for transmission (for example, instead of selecting a network coding packet with a highest score) may prevent network coding devices in an area from transmitting network coding packets including data, information, or transport blocks from the same packets or the same combination of packets. In some implementations, however, the network coding device 405 may select the first network coding packet 425 from the subset of network coding packets with scores satisfying the scoring threshold based on the first network coding packet 425 having a highest score among the subset of network coding packets.

The network coding device 405 may transmit the first network coding packet 425 to the UE 115-c. In some examples, a format of the first network coding packet 425 may be similar to network coding packets from other network coding devices (for example, fixed or preconfigured network coding devices). In some examples, the network coding device 405 may add a bit to a header of the first network coding packet indicating that an original transmitter of a packet retransmitted in the first network coding packet is to transmit an ACK or NACK for the first network coding packet 425. The original transmitter may transmit the ACK or the NACK to the network coding device 405 in a PSFCH in accordance with one or more sidelink feedback rules.

The first UE 115-d may receive the first network coding packet 425 from the network coding device 405 and may skip retransmission of the first packet 410 based on receiving the first network coding packet 425. The first UE 115-d may also increment a HARQ identifier (ID) for the first packet 410 (for example, the HARQ ID may be incremented by one). In some examples, the first UE 115-d may transmit an ACK to the network coding device 405 after receiving the first network coding packet 425 to confirm that the first UE 115-d may monitor or wait for feedback for the first packet 410 (for example, from the UE 115-c). In some other examples, the network coding device 405 may keep track of feedback or collect feedback from the UE 115-c and may later transmit the collected feedback to the UE 115-d. For instance, the network coding device 405 may transmit an ACK to the UE 115-d after receiving an ACK for the first packet 410 from the UE 115-c.

The UE 115-d may determine a resource to monitor for feedback for the first packet 410 from the UE 115-c or the network coding device 405. For instance, a slot or resource for feedback for the first packet 410 may be computed based on a slot or resource carrying the first network coding packet 425 or an identifier of the first packet 410. The UE 115-d may determine the resource carrying the first network coding packet 425 upon receiving the first network coding packet 425, and the UE 115-d may determine the identifier of the first packet 410 from a header of the first network coding packet 425 (for example, the identifier of the first packet 410 may be included in the header of the first network coding packet 425). A computation equation or how to determine the resource to monitor for feedback for the first packet 410 may be preconfigured at the network coding device 405, or a network entity 105 may signal the computation equation or how to determine the resource to monitor for the feedback for the first packet 410 to the network coding device 405.

Complementary network coding devices such as the network coding device 405 in the wireless communications system 400 may coexist with other types of network coding devices. For instance, the network coding device 405 may assist in retransmitting packets that other types of network coding devices fail to ACK. In some examples, a UE 115 (for example, the UE 115-d the UE 115-e, or the UE 115-f) may select the network coding device 405 to retransmit a packet based on one or more criteria (for example, encoder selection criteria). The one or more criteria may be preconfigured at the UE 115, or a network entity 105 may signal the one or more criteria to the UE 115. The one or more criteria may include a buffer size, a remaining power, or location information for a network coding device. The one or more criteria may be different than criteria for selecting other types of network coding devices. Alternatively, the one or more criteria may be similar to criteria for selecting other types of network coding devices, but there may be a different set of parameters preconfigured or signaled by a network entity 105 (for example, a maximum quantity of network coding devices of a given type in an area). In some examples, complementary network coding devices may also signal to other devices indicating that the complementary network coding devices are operating in the wireless communications system 400. For instance, one bit in a message may be reserved for indicating that a network coding device is a complementary network coding device.

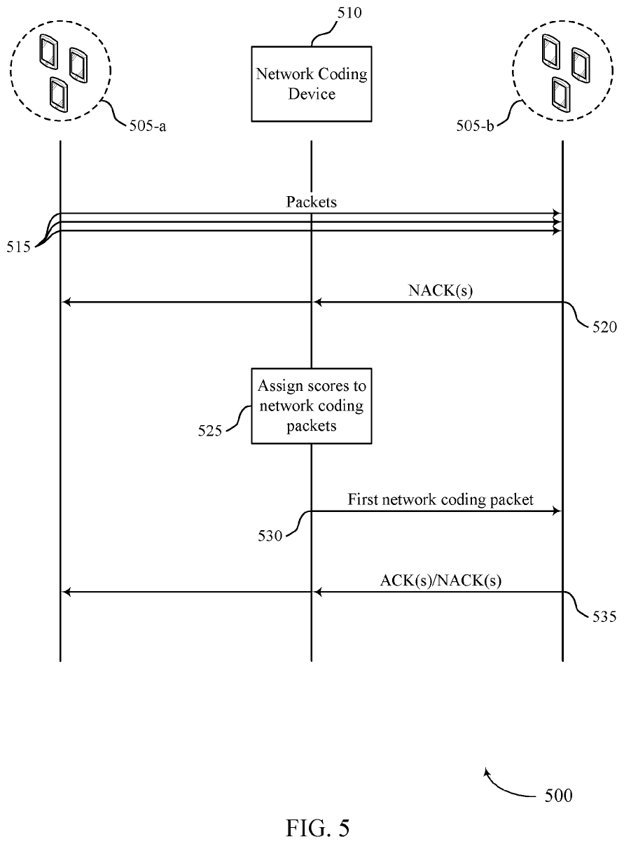

FIG. 5 illustrates an example of a process flow 500 that supports distributed network coding with complementary network coding devices in accordance with one or more aspects of the present disclosure. The process flow 500 includes one or more first UEs 505-a, which may include UEs 115 described with reference to FIGS. 1-4. The process flow 500 also includes one or more second UEs 505-b, which may include UEs 115 described with reference to FIGS. 1-4. The process flow 500 also includes a network coding device 510, which may be an example of a network coding device described with reference to FIGS. 1-4. The process flow 500 may implement aspects of the wireless communications system 100 or the wireless communications system 400. For instance, the process flow 500 may support efficient techniques for distributed network coding with complementary network coding devices.

In the following description of the process flow 500, the signaling exchanged between the one or more first UEs 505-a, the network coding device 510, and the one or more second UEs 505-b may be exchanged in a different order than the example order shown, or the operations performed by the one or more first UEs 505-a, the network coding device 510, and the one or more second UEs 505-b may be performed in different orders or at different times. Some operations may also be omitted from the process flow 500, and other operations may be added to the process flow 500.

At 515, the one or more first UEs 505-a may transmit a first set of packets to the one or more second UEs 505-a. For instance, each of the one or more first UEs 505-a may transmit a packet to at least one of the one or more second UEs 505-b, and each of the one or more second UEs 505-b may receive a packet from at least one of the one or more first UEs 505-a. Each packet in the first set of packets may be referred to as a source packet.

At 520, the one or more second UEs 505-b may transmit NACKs based on failing to receive at least a subset of the first set of packets from the one or more first UEs 505-a. For instance, each of the one or more second UEs 505-b may transmit a NACK based on failing to successfully receive a packet from at least one of the one or more first UEs 505-a.

The network coding device 510 may receive the first set of packets from the one or more first UEs 505-a and may determine that at least one of the one or more second UEs 505-b failed to successfully receive each of the first set of packets. For instance, the network coding device 510 may monitor for ACK or NACK feedback from the one or more second UEs 505-b, and the network coding device 510 may receive a NACK from each of the one or more second UEs 505-b for a packet from at least one of the one or more first UEs 505-a. The network coding device 510 may then determine to retransmit at least a subset of the first set of packets based on determining that at least one of the one or more second UEs 505-b failed to successfully receive each of the first set of packets. In some examples, the network coding device 510 may transmit an indication that the network coding device 510 is a complementary network coding device configured to assist with retransmitting packets.

At 525, the network coding device 510 may assign respective scores to multiple network coding packets based on receiving the first set of packets from the one or more first UEs 505-a. The multiple network coding packets may include data, information, or transport blocks from different subsets of the first set of packets received from the one or more first UEs 505-a. That is, each network coding packet may include a different subset of the first set of packets received from the one or more first UEs 505-a. A score assigned to each network coding packet may rank the network coding packet among the multiple network coding packets. The network coding device 510 may compute (for example, generate) each of the multiple network coding packets or compute a score for each of the multiple network coding packets.

In an example, the network coding device 510 may assign a score to a network coding packet based on an expected quantity of NACK-to-ACK flips associated with the network coding packet. The network coding packet may include data, information, or transport blocks from a subset of the first set of packets, and the subset of the first set of packets may be intended for a subset of the one or more second UEs 505-b. The expected quantity of NACK-to-ACK flips associated with the network coding packet may be based on a quantity of retransmissions (for example, past retransmissions) of packets successfully received by each UE of the subset of the one or more second UEs 505-b from the network coding device 510. The network coding device 510 may monitor for ACK or NACK feedback from each UE of the subset of the one or more second UEs 505-b to determine the quantity of retransmissions of packets successfully received by each UE of the subset of the one or more second UEs 505-b. The network coding device 510 may then predict the quantity of NACK-to-ACK flips associated with a network coding packet based on the quantity of retransmissions of packets successfully received by each UE of the subset of the one or more second UEs 505-b. For example, the network coding device 510 may predict a quantity of the subset of the first set of packets in the network coding packet to be successfully received by the subset of the one or more second UEs 505-b.

A first subset of the first set of network coding packets may have scores satisfying a scoring threshold. The network coding device 510 may receive an indication of the scoring threshold from a network entity. The network coding device 510 may select a first network coding packet for transmission from the first subset of the network coding packets. For instance, the network coding device 510 may select the first network coding packet for transmission based on the first network coding packet being assigned a score satisfying the scoring threshold. The scoring threshold may be based on channel conditions (for example, a quantity of UEs in a wireless communications system or RSRP measurements between the one or more first UEs 505-a and the one or more second UEs 505-b). In some examples, the network coding device 510 may randomly select the first network coding packet from the first subset of the network coding packets. In some other examples, the network coding device 510 may select the first network coding packet from the first subset of the network coding packets based on the first network coding packet being assigned a highest score of the scores assigned to the network coding packets in the first subset of network coding packets.

At 530, the network coding device 510 may transmit the first network coding packet to the one or more second UEs 505-b. In some examples, a first UE of the one or more first UEs 505-a may receive the first network coding packet and may determine that the first network coding packet includes data, information, or transport blocks from a first packet originally transmitted by the first UE. The first UE may then skip retransmission of the first packet based on receiving the first network coding packet, but the first UE may monitor for ACK or NACK feedback for the first packet despite skipping retransmission of the first packet. For instance, the first UE may monitor for the ACK or NACK feedback for the first packet based on the network coding device 510 being a complementary network coding device. The first UE may also update (for example, increment) a HARQ identifier for the first packet based on receiving the first network coding packet from the network coding device 510.

At 535, the one or more second UEs 505-b may transmit ACKs or NACKs for packets retransmitted in the first network coding packet.

In some examples, the network coding device 510 may transmit an indication that each UE of the one or more first UEs 505-a (for example, the UEs that originally transmitted a packet retransmitted in the first network coding packet) is to transmit an ACK to the network coding device 510 after receiving the first network coding packet. A first UE of the one or more first UEs 505-a may transmit an ACK to the network coding device 510 after receiving the first network coding packet. The first UE may be an original transmitter of a first packet intended for a second UE, and the first packet may be retransmitted in the first network coding packet. The first UE may then monitor for ACK or NACK from the second UE for the first packet based on receiving the first network coding packet. The network coding device 510 may also avoid transmitting ACK or NACK feedback for the first packet to the first UE based on receiving the ACK from the first UE.

In some other examples, after receiving a first packet from a first UE of the one or more first UEs 505-a and retransmitting the first packet in the first network coding packet, the network coding device 510 may receive an ACK or NACK from a second UE for the first packet, and the network coding device 510 may transmit the ACK or NACK to the first UE. The first UE may then receive the ACK or NACK from the network coding device 510. For instance, the first UE may receive an ACK indicating that the second UE successfully received the first packet.

Whether the first UE monitors for ACK or NACK feedback from the second UE or from the network coding device 510, it may be appropriate for the first UE to determine a resource to monitor for the ACK or NACK feedback. For instance, the first UE may determine a first resource to monitor for the ACK or NACK feedback from the second UE based on a second resource on which the first network coding packet is received, an identifier of the first packet, or an identifier of the first network coding packet. In some examples, the first UE may receive, from the network coding device 510 or a network entity 105, an indication of how to determine the first resource to monitor for the ACK or NACK feedback.

In some examples, the network coding device 510 may determine the first set of packets from which to select a subset of packets for retransmission based on one or more factors. For instance, the network coding device 510 may receive other packets from other UEs (for example, other than the one or more first UEs 505-a), but the network coding device 510 may avoid retransmitting these packets. In some examples, the network coding device 510 may include a packet in the first set of packets for potential retransmission in examples in which a quantity of retransmissions of the packet by the network coding device 510 fails to exceed a maximum quantity of transmissions. The network coding device 510 may independently determine the maximum quantity of transmissions for the packet or receive an indication of the maximum quantity of transmissions for the packet. In some other examples, the network coding device 510 may select the first set of packets for potential retransmission based on failing to receive an ACK for each of the first set of packets from another network coding device.

In some examples, a first UE of the one or more first UEs 505-a may select the network coding device 510 to retransmit a first packet based on one or more criteria. The first packet may be originally transmitted by the first UE of the one or more first UEs 505-a. The one or more criteria may include a buffer of the network coding device 510, a remaining power of the network coding device 510, or location information associated with the network coding device 510. For instance, the first UE may select the network coding device 510 to retransmit the first packet in examples in which an available space in the buffer of the network coding device 510 satisfies a threshold, a remaining power of the network coding device 510 satisfies a threshold, or a location of the network coding device 510 is within a threshold distance from a second UE for which the first packet is intended. In some implementations, the first UE may receive an indication of the one or more criteria from a network entity 105.

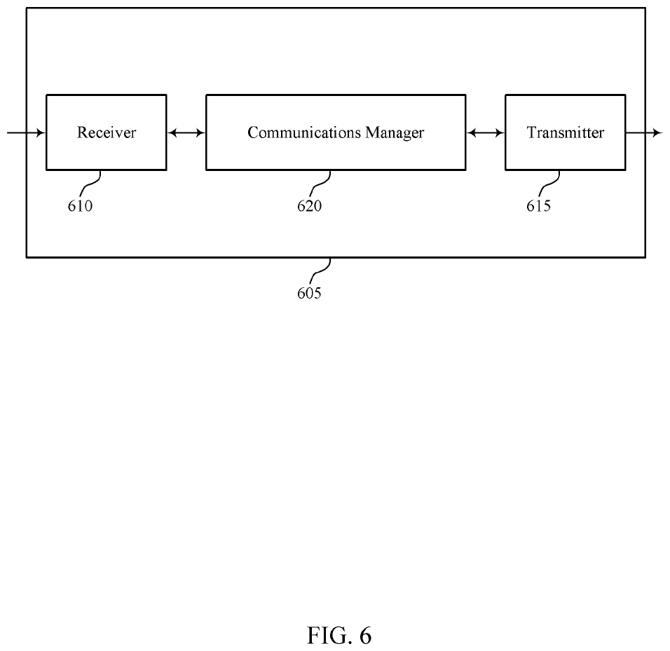

FIG. 6 shows a block diagram of a device 605 that supports distributed network coding with complementary network coding devices in accordance with one or more aspects of the present disclosure. The device 605 may be an example of aspects of a UE 115 as described herein. The device 605 may include a receiver 610, a transmitter 615, and a communications manager 620. The communications manager 620 can be implemented, at least in part, by one or both of a modem and a processor. Each of these components may be in communication with one another (for example, via one or more buses).

The receiver 610 may provide a means for receiving information such as packets, user data, control information, or any combination thereof associated with various information channels (for example, control channels, data channels, information channels related to distributed network coding with complementary network coding devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (for example, control channels, data channels, information channels related to distributed network coding with complementary network coding devices). In some examples, the transmitter 615 may be co-located with a receiver 610 in a transceiver component. The transmitter 615 may utilize a single antenna or a set of multiple antennas.

The communications manager 620, the receiver 610, the transmitter 615, or various combinations thereof or various components thereof may be examples of means for performing various aspects of distributed network coding with complementary network coding devices as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (for example, in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally, or alternatively, in some examples, the communications manager 620, the receiver 610, the transmitter 615, or various combinations or components thereof may be implemented in code (for example, as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (for example, configured as or otherwise supporting a means for performing the functions described in the present disclosure).

In some examples, the communications manager 620 may be configured to perform various operations (for example, receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a network coding device in accordance with examples as disclosed herein. For example, the communications manager 620 may be configured as or otherwise support a means for receiving a set of multiple source packets from one or more first user equipment (UEs). The communications manager 620 may be configured as or otherwise support a means for assigning a score to a first network coding packet of a set of multiple network coding packets, each network coding packet of the set of multiple network coding packets including one or more transport blocks from a different respective subset of source packets of the set of multiple source packets. The communications manager 620 may be configured as or otherwise support a means for transmitting, to one or more second UEs, the first network coding packet based on the score satisfying a scoring threshold.

Additionally, or alternatively, the communications manager 620 may support wireless communication at a first UE in accordance with examples as disclosed herein. For example, the communications manager 620 may be configured as or otherwise support a means for transmitting a first packet to at least a second UE. The communications manager 620 may be configured as or otherwise support a means for receiving a first network coding packet from a network coding device, the first network coding packet including one or more transport blocks from the first packet based on the second UE failing to successfully receive the first packet. The communications manager 620 may be configured as or otherwise support a means for skipping retransmission of the first packet based on receiving the first network coding packet from the network coding device. The communications manager 620 may be configured as or otherwise support a means for monitoring for acknowledgment or negative acknowledgment feedback for the first packet despite skipping retransmission of the first packet.

By including or configuring the communications manager 620 in accordance with examples as described herein, the device 605 (for example, a processor controlling or otherwise coupled with the receiver 610, the transmitter 615, the communications manager 620, or a combination thereof) may support techniques for reduced processing, reduced power consumption, and more efficient utilization of communication resources. Because the device 605 may facilitate distributed network coding by efficiently selecting combinations of packets for network coding and enabling original transmitters of packets to manage retransmissions of the packets, overhead associated with retransmissions may be reduced while the likelihood that packets may be successfully received may increase. As such, processing and power consumption associated with retransmissions of the packet may be reduced and less resources may be used for the retransmissions.

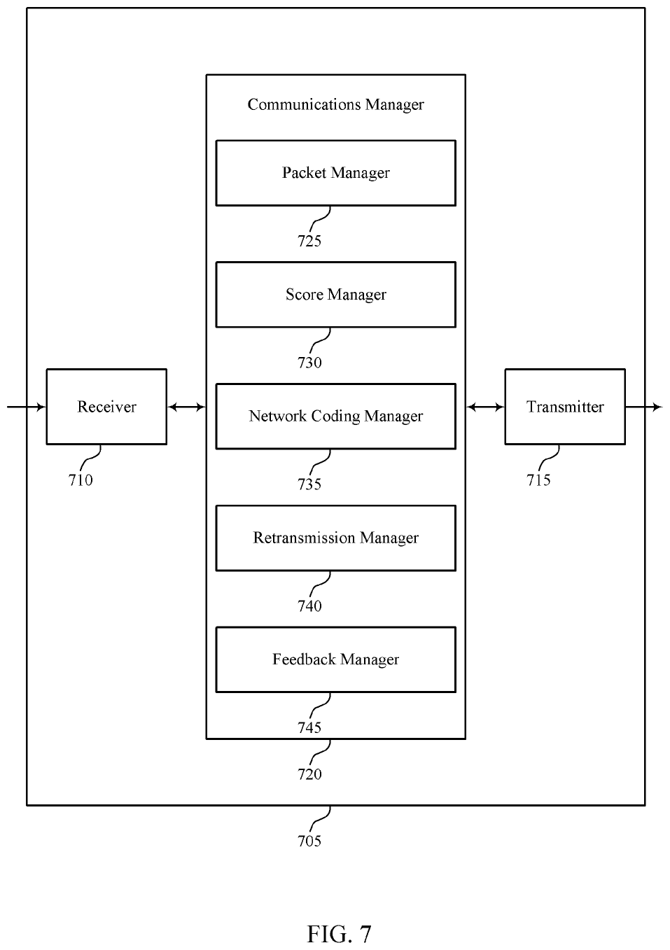

FIG. 7 shows a block diagram of a device 705 that supports distributed network coding with complementary network coding devices in accordance with one or more aspects of the present disclosure. The device 705 may be an example of aspects of a device 605 or a UE 115 as described herein. The device 705 may include a receiver 710, a transmitter 715, and a communications manager 720. The communications manager 720 can be implemented, at least in part, by one or both of a modem and a processor. Each of these components may be in communication with one another (for example, via one or more buses).

The receiver 710 may provide a means for receiving information such as packets, user data, control information, or any combination thereof associated with various information channels (for example, control channels, data channels, information channels related to distributed network coding with complementary network coding devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (for example, control channels, data channels, information channels related to distributed network coding with complementary network coding devices). In some examples, the transmitter 715 may be co-located with a receiver 710 in a transceiver component. The transmitter 715 may utilize a single antenna or a set of multiple antennas.

The device 705, or various components thereof, may be an example of means for performing various aspects of distributed network coding with complementary network coding devices as described herein. For example, the communications manager 720 may include a packet manager 725, a score manager 730, a network coding manager 735, a retransmission manager 740, a feedback manager 745, or any combination thereof. In some examples, the communications manager 720, or various components thereof, may be configured to perform various operations (for example, receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a network coding device in accordance with examples as disclosed herein. The packet manager 725 may be configured as or otherwise support a means for receiving a set of multiple source packets from one or more first user equipment (UEs). The score manager 730 may be configured as or otherwise support a means for assigning a score to a first network coding packet of a set of multiple network coding packets, each network coding packet of the set of multiple network coding packets including one or more transport blocks from a different respective subset of source packets of the set of multiple source packets. The network coding manager 735 may be configured as or otherwise support a means for transmitting, to one or more second UEs, the first network coding packet based on the score satisfying a scoring threshold.

Additionally, or alternatively, the communications manager 720 may support wireless communication at a first UE in accordance with examples as disclosed herein. The packet manager 725 may be configured as or otherwise support a means for transmitting a first packet to at least a second UE. The network coding manager 735 may be configured as or otherwise support a means for receiving a first network coding packet from a network coding device, the first network coding packet including one or more transport blocks from the first packet based on the second UE failing to successfully receive the first packet. The retransmission manager 740 may be configured as or otherwise support a means for skipping retransmission of the first packet based on receiving the first network coding packet from the network coding device. The feedback manager 745 may be configured as or otherwise support a means for monitoring for acknowledgment or negative acknowledgment feedback for the first packet despite skipping retransmission of the first packet.

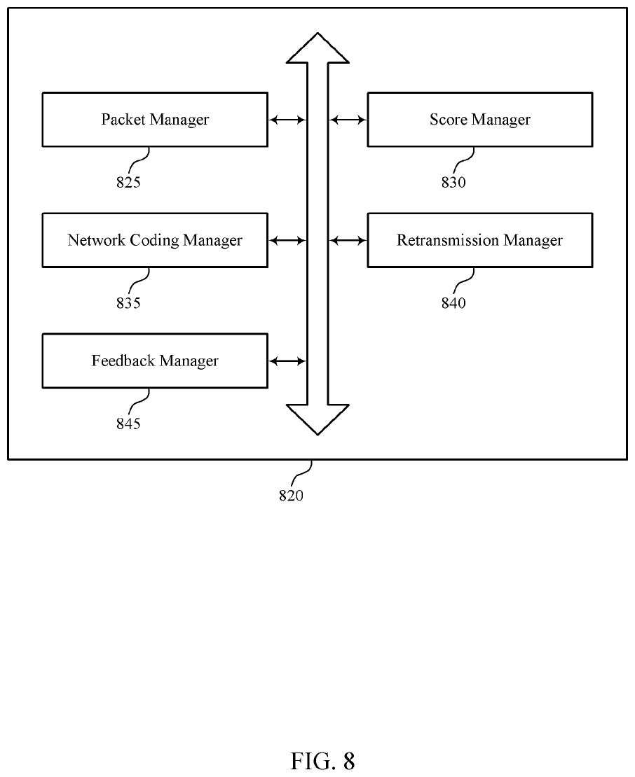

FIG. 8 shows a block diagram of a communications manager 820 that supports distributed network coding with complementary network coding devices in accordance with one or more aspects of the present disclosure. The communications manager 820, or various components thereof, may be an example of means for performing various aspects of distributed network coding with complementary network coding devices as described herein. For example, the communications manager 820 may include a packet manager 825, a score manager 830, a network coding manager 835, a retransmission manager 840, a feedback manager 845, or any combination thereof. Each of these components may communicate, directly or indirectly, with one another (for example, via one or more buses).

The communications manager 820 may support wireless communication at a network coding device in accordance with examples as disclosed herein. The packet manager 825 may be configured as or otherwise support a means for receiving a set of multiple source packets from one or more first user equipment (UEs). The score manager 830 may be configured as or otherwise support a means for assigning a score to a first network coding packet of a set of multiple network coding packets, each network coding packet of the set of multiple network coding packets including one or more transport blocks from a different respective subset of source packets of the set of multiple source packets. The network coding manager 835 may be configured as or otherwise support a means for transmitting, to one or more second UEs, the first network coding packet based on the score satisfying a scoring threshold.

In some examples, the score manager 830 may be configured as or otherwise support a means for receiving an indication of the scoring threshold from a network entity, where the scoring threshold is based on one or more channel conditions.

In some examples, the retransmission manager 840 may be configured as or otherwise support a means for predicting a quantity of a subset of the set of multiple source packets associated with the first network coding packet to be successfully received by the one or more second UEs, where assigning the score to the first network coding packet is based on the predicting.

In some examples, the feedback manager 845 may be configured as or otherwise support a means for monitoring for acknowledgment feedback or negative acknowledgment feedback from each UE of the one or more second UEs, where the predicting is based on the monitoring.

In some examples, the score manager 830 may be configured as or otherwise support a means for assigning respective scores to the set of multiple network coding packets, where a subset of the scores assigned to a subset of the set of multiple network coding packets satisfies the scoring threshold. In some examples, the network coding manager 835 may be configured as or otherwise support a means for selecting the first network coding packet for transmission from the subset of the set of multiple network coding packets.

In some examples, the first network coding packet is randomly selected from the subset of the set of multiple network coding packets, or the first network coding packet is selected from the subset of the set of multiple network coding packets based on the first network coding packet being assigned a highest score of the subset of scores assigned to the subset of the set of multiple network coding packets.

In some examples, the network coding manager 835 may be configured as or otherwise support a means for determining a maximum quantity of transmissions for a packet of a subset of the set of multiple source packets associated with the first network coding packet, where the first network coding packet includes one or more transport blocks from the packet based on a quantity of transmissions, by the network coding device, of the packet failing to exceed the maximum quantity of transmissions.

In some examples, the network coding manager 835 may be configured as or otherwise support a means for receiving an indication of the maximum quantity of transmissions for the packet, where determining the maximum quantity of transmissions for the packet is based on receiving the indication of the maximum quantity of transmissions for the packet.

In some examples, the first network coding packet includes an indication that each UE of a subset of the one or more first UEs associated with the first network coding packet is to transmit an acknowledgment to the network coding device after receiving the first network coding packet.

In some examples, the feedback manager 845 may be configured as or otherwise support a means for receiving the acknowledgment from each UE of the subset of the one or more first UEs based on the first network coding packet including the indication. In some examples, the feedback manager 845 may be configured as or otherwise support a means for avoiding transmitting acknowledgment or negative acknowledgment feedback to the subset of the one or more first UEs based on receiving the acknowledgment from each UE of the subset of the one or more first UEs.

In some examples, the packet manager 825 may be configured as or otherwise support a means for receiving, from a first UE of the one or more first UEs, a first packet of a subset of the set of multiple source packets associated with the first network coding packet. In some examples, the feedback manager 845 may be configured as or otherwise support a means for receiving an acknowledgment from a second UE for the first packet. In some examples, the feedback manager 845 may be configured as or otherwise support a means for transmitting an acknowledgment to the first UE indicating that the second UE successfully received the first packet.

In some examples, the packet manager 825 may be configured as or otherwise support a means for selecting the set of multiple source packets received from the one or more first UEs for retransmission based on failing to receive an acknowledgment for each of the set of multiple source packets from any other network coding device.

In some examples, the network coding manager 835 may be configured as or otherwise support a means for transmitting an indication that the network coding device includes a complementary network coding device configured to assist with retransmitting the set of multiple source packets.

In some examples, the network coding manager 835 may be configured as or otherwise support a means for computing each of the set of multiple network coding packets.

Additionally, or alternatively, the communications manager 820 may support wireless communication at a first UE in accordance with examples as disclosed herein. In some examples, the packet manager 825 may be configured as or otherwise support a means for transmitting a first packet to at least a second UE. In some examples, the network coding manager 835 may be configured as or otherwise support a means for receiving a first network coding packet from a network coding device, the first network coding packet including one or more transport blocks from the first packet based on the second UE failing to successfully receive the first packet. The retransmission manager 840 may be configured as or otherwise support a means for skipping retransmission of the first packet based on receiving the first network coding packet from the network coding device. The feedback manager 845 may be configured as or otherwise support a means for monitoring for acknowledgment or negative acknowledgment feedback for the first packet despite skipping retransmission of the first packet.

In some examples, the retransmission manager 840 may be configured as or otherwise support a means for updating a hybrid automatic repeat request identifier for the first packet based on receiving the first network coding packet from the network coding device.

In some examples, the first network coding packet includes an indication that the first UE is to transmit an acknowledgment to the network coding device after receiving the first network coding packet, and the feedback manager 845 may be configured as or otherwise support a means for transmitting the acknowledgment to the network coding device based on the first network coding packet including the indication.

In some examples, the feedback manager 845 may be configured as or otherwise support a means for monitoring for an acknowledgment or a negative acknowledgment from the second UE for the first packet based on receiving the first network coding packet.

In some examples, the feedback manager 845 may be configured as or otherwise support a means for determining a first resource to monitor for the acknowledgment or negative acknowledgment from the second UE based on a second resource on which the first network coding packet is received, an identifier of the first packet or the first network coding packet, or a combination thereof.

In some examples, the feedback manager 845 may be configured as or otherwise support a means for receiving, from the network coding device or a network entity, an indication of how to determine the first resource, where determining the first resource is based on the indication of how to determine the first resource.

In some examples, the feedback manager 845 may be configured as or otherwise support a means for receiving, from the network coding device, an acknowledgment indicating that the second UE successfully received the first packet.

In some examples, the network coding manager 835 may be configured as or otherwise support a means for selecting the network coding device to retransmit the first packet based on one or more criteria, the one or more criteria including a buffer of the network coding device, a remaining power of the network coding device, location information associated with the network coding device, or a combination thereof.

In some examples, the network coding manager 835 may be configured as or otherwise support a means for receiving an indication of the one or more criteria from a network entity, where selecting the network coding device to retransmit the first packet is based on receiving the indication of the one or more criteria.

In some examples, the network coding manager 835 may be configured as or otherwise support a means for receiving an indication that the network coding device includes a complementary network coding device configured to assist with retransmitting the first packet, where the monitoring for the acknowledgment or negative acknowledgment feedback for the first packet is based on the network coding device including the complementary network coding device.

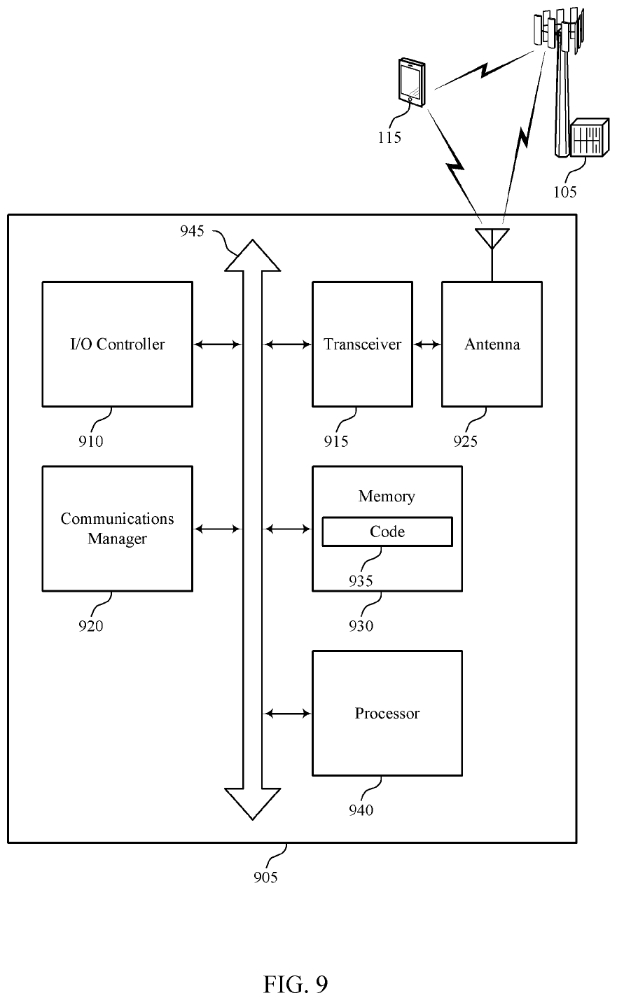

FIG. 9 shows a diagram of a system including a device 905 that supports distributed network coding with complementary network coding devices in accordance with one or more aspects of the present disclosure. The device 905 may be an example of or include the components of a device 605, a device 705, or a UE 115 as described herein. The device 905 may communicate (for example, wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (for example, operatively, communicatively, functionally, electronically, electrically) via one or more buses (for example, a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (for example, when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (for example, the memory 930) to cause the device 905 to perform various functions (for example, functions or tasks supporting distributed network coding with complementary network coding devices). For example, the device 905 or a component of the device 905 may include a processor 940 and memory 930 coupled with or to the processor 940, the processor 940 and memory 930 configured to perform various functions described herein.

The communications manager 920 may support wireless communication at a network coding device in accordance with examples as disclosed herein. For example, the communications manager 920 may be configured as or otherwise support a means for receiving a set of multiple source packets from one or more first user equipment (UEs). The communications manager 920 may be configured as or otherwise support a means for assigning a score to a first network coding packet of a set of multiple network coding packets, each network coding packet of the set of multiple network coding packets including one or more transport blocks from a different respective subset of source packets of the set of multiple source packets. The communications manager 920 may be configured as or otherwise support a means for transmitting, to one or more second UEs, the first network coding packet based on the score satisfying a scoring threshold.

Additionally, or alternatively, the communications manager 920 may support wireless communication at a first UE in accordance with examples as disclosed herein. For example, the communications manager 920 may be configured as or otherwise support a means for transmitting a first packet to at least a second UE. The communications manager 920 may be configured as or otherwise support a means for receiving a first network coding packet from a network coding device, the first network coding packet including one or more transport blocks from the first packet based on the second UE failing to successfully receive the first packet. The communications manager 920 may be configured as or otherwise support a means for skipping retransmission of the first packet based on receiving the first network coding packet from the network coding device. The communications manager 920 may be configured as or otherwise support a means for monitoring for acknowledgment or negative acknowledgment feedback for the first packet despite skipping retransmission of the first packet.

By including or configuring the communications manager 920 in accordance with examples as described herein, the device 905 may support techniques for reduced processing, reduced power consumption, and more efficient utilization of communication resources. Because the device 905 may facilitate distributed network coding by efficiently selecting combinations of packets for network coding and enabling original transmitters of packets to manage retransmissions of the packets, overhead associated with retransmissions may be reduced while the likelihood that packets may be successfully received may increase. As such, processing and power consumption associated with retransmissions of the packet may be reduced and less resources may be used for the retransmissions.

In some examples, the communications manager 920 may be configured to perform various operations (for example, receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of distributed network coding with complementary network coding devices as described herein, or the processor 940 and the memory 930 may be otherwise configured to perform or support such operations.

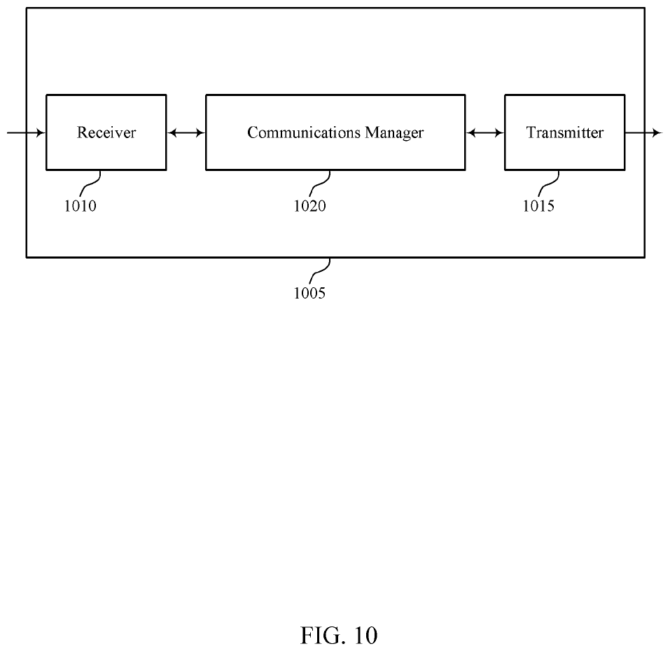

FIG. 10 shows a block diagram of a device 1005 that supports distributed network coding with complementary network coding devices in accordance with one or more aspects of the present disclosure. The device 1005 may be an example of aspects of a network entity 105 as described herein. The device 1005 may include a receiver 1010, a transmitter 1015, and a communications manager 1020. The communications manager 1020 can be implemented, at least in part, by one or both of a modem and a processor. Each of these components may be in communication with one another (for example, via one or more buses).

The receiver 1010 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (for example, electrical, fiber optic) interfaces, wireless interfaces, or any combination thereof.

The transmitter 1015 may provide a means for outputting (for example, transmitting, providing, conveying, sending) information generated by other components of the device 1005. For example, the transmitter 1015 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (for example, electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of distributed network coding with complementary network coding devices as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (for example, in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally, or alternatively, in some examples, the communications manager 1020, the receiver 1010, the transmitter 1015, or various combinations or components thereof may be implemented in code (for example, as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (for example, configured as or otherwise supporting a means for performing the functions described in the present disclosure).

In some examples, the communications manager 1020 may be configured to perform various operations (for example, receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network coding device in accordance with examples as disclosed herein. For example, the communications manager 1020 may be configured as or otherwise support a means for receiving a set of multiple source packets from one or more first user equipment (UEs). The communications manager 1020 may be configured as or otherwise support a means for assigning a score to a first network coding packet of a set of multiple network coding packets, each network coding packet of the set of multiple network coding packets including one or more transport blocks from a different respective subset of source packets of the set of multiple source packets. The communications manager 1020 may be configured as or otherwise support a means for transmitting, to one or more second UEs, the first network coding packet based on the score satisfying a scoring threshold.

By including or configuring the communications manager 1020 in accordance with examples as described herein, the device 1005 (for example, a processor controlling or otherwise coupled with the receiver 1010, the transmitter 1015, the communications manager 1020, or a combination thereof) may support techniques for reduced processing, reduced power consumption, and more efficient utilization of communication resources. Because the device 1005 may facilitate distributed network coding by efficiently selecting combinations of packets for network coding and enabling original transmitters of packets to manage retransmissions of the packets, overhead associated with retransmissions may be reduced while the likelihood that packets may be successfully received may increase. As such, processing and power consumption associated with retransmissions of the packet may be reduced and less resources may be used for the retransmissions.

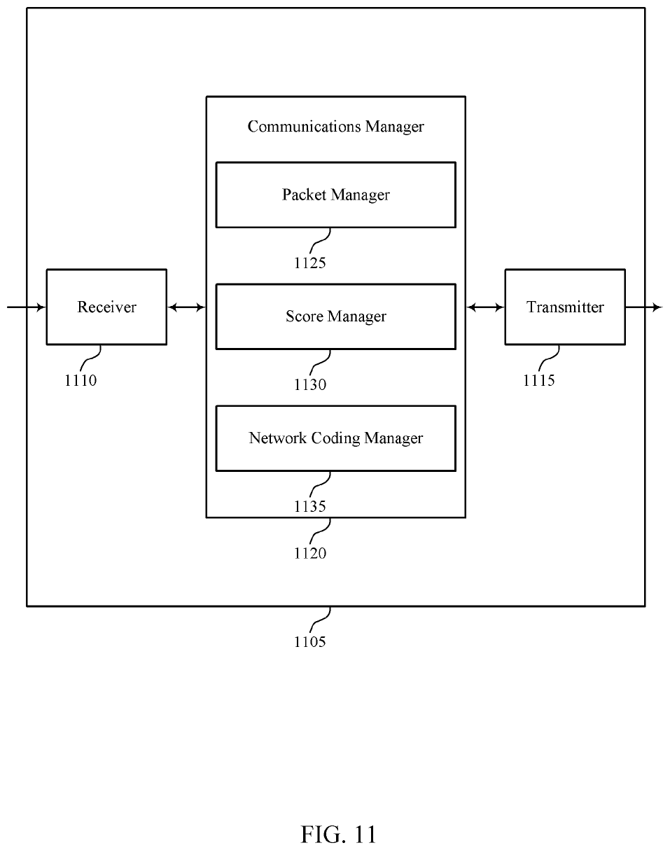

FIG. 11 shows a block diagram of a device 1105 that supports distributed network coding with complementary network coding devices in accordance with one or more aspects of the present disclosure. The device 1105 may be an example of aspects of a device 1005 or a network entity 105 as described herein. The device 1105 may include a receiver 1110, a transmitter 1115, and a communications manager 1120. The communications manager 1120 can be implemented, at least in part, by one or both of a modem and a processor. Each of these components may be in communication with one another (for example, via one or more buses).

The receiver 1110 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (for example, electrical, fiber optic) interfaces, wireless interfaces, or any combination thereof.

The transmitter 1115 may provide a means for outputting (for example, transmitting, providing, conveying, sending) information generated by other components of the device 1105. For example, the transmitter 1115 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (for example, electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of distributed network coding with complementary network coding devices as described herein. For example, the communications manager 1120 may include a packet manager 1125, a score manager 1130, a network coding manager 1135, or any combination thereof. In some examples, the communications manager 1120, or various components thereof, may be configured to perform various operations (for example, receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network coding device in accordance with examples as disclosed herein. The packet manager 1125 may be configured as or otherwise support a means for receiving a set of multiple source packets from one or more first user equipment (UEs). The score manager 1130 may be configured as or otherwise support a means for assigning a score to a first network coding packet of a set of multiple network coding packets, each network coding packet of the set of multiple network coding packets including one or more transport blocks from a different respective subset of source packets of the set of multiple source packets. The network coding manager 1135 may be configured as or otherwise support a means for transmitting, to one or more second UEs, the first network coding packet based on the score satisfying a scoring threshold.

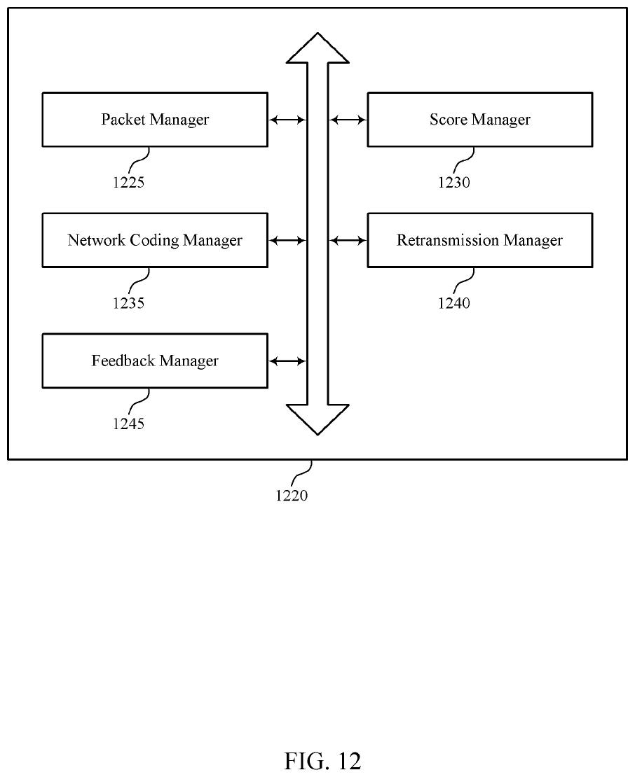

FIG. 12 shows a block diagram of a communications manager 1220 that supports distributed network coding with complementary network coding devices in accordance with one or more aspects of the present disclosure. The communications manager 1220, or various components thereof, may be an example of means for performing various aspects of distributed network coding with complementary network coding devices as described herein. For example, the communications manager 1220 may include a packet manager 1225, a score manager 1230, a network coding manager 1235, a retransmission manager 1240, a feedback manager 1245, or any combination thereof. Each of these components may communicate, directly or indirectly, with one another (for example, via one or more buses) which may include communications within a protocol layer of a protocol stack, communications associated with a logical channel of a protocol stack (for example, between protocol layers of a protocol stack, within a device, component, or virtualized component associated with a network entity 105, between devices, components, or virtualized components associated with a network entity 105), or any combination thereof.

The communications manager 1220 may support wireless communication at a network coding device in accordance with examples as disclosed herein. The packet manager 1225 may be configured as or otherwise support a means for receiving a set of multiple source packets from one or more first user equipment (UEs). The score manager 1230 may be configured as or otherwise support a means for assigning a score to a first network coding packet of a set of multiple network coding packets, each network coding packet of the set of multiple network coding packets including one or more transport blocks from a different respective subset of source packets of the set of multiple source packets. The network coding manager 1235 may be configured as or otherwise support a means for transmitting, to one or more second UEs, the first network coding packet based on the score satisfying a scoring threshold.

In some examples, the score manager 1230 may be configured as or otherwise support a means for receiving an indication of the scoring threshold from a network entity, where the scoring threshold is based on one or more channel conditions.

In some examples, the retransmission manager 1240 may be configured as or otherwise support a means for predicting a quantity of a subset of the plurality of source packets associated with the first network coding packet to be successfully received by the one or more second UEs, where assigning the score to the first network coding packet is based on the predicting.

In some examples, the feedback manager 1245 may be configured as or otherwise support a means for monitoring for acknowledgment feedback or negative acknowledgment feedback from each UE of the one or more second UEs, where the predicting is based on the monitoring.

In some examples, the score manager 1230 may be configured as or otherwise support a means for assigning respective scores to the set of multiple network coding packets, where a subset of the scores assigned to a subset of the set of multiple network coding packets satisfies the scoring threshold. In some examples, the network coding manager 1235 may be configured as or otherwise support a means for selecting the first network coding packet for transmission from the subset of the set of multiple network coding packets.

In some examples, the first network coding packet is randomly selected from the subset of the set of multiple network coding packets, or the first network coding packet is selected from the subset of the set of multiple network coding packets based on the first network coding packet being assigned a highest score of the subset of scores assigned to the subset of the set of multiple network coding packets.

In some examples, the network coding manager 1235 may be configured as or otherwise support a means for determining a maximum quantity of transmissions for a packet of a subset of the set of multiple source packets associated with the first network coding packet, where the first network coding packet includes one or more transport blocks from the packet based on a quantity of transmissions, by the network coding device, of the packet failing to exceed the maximum quantity of transmissions.

In some examples, the network coding manager 1235 may be configured as or otherwise support a means for receiving an indication of the maximum quantity of transmissions for the packet, where determining the maximum quantity of transmissions for the packet is based on receiving the indication of the maximum quantity of transmissions for the packet.

In some examples, the first network coding packet includes an indication that each UE of a subset of the one or more first UEs associated with the first network coding packet is to transmit an acknowledgment to the network coding device after receiving the first network coding packet.

In some examples, the feedback manager 1245 may be configured as or otherwise support a means for receiving the acknowledgment from each UE of the subset of the one or more first UEs based on the first network coding packet including the indication. In some examples, the feedback manager 1245 may be configured as or otherwise support a means for avoiding transmitting acknowledgment or negative acknowledgment feedback to the subset of the one or more first UEs based on receiving the acknowledgment from each UE of the subset of the one or more first UEs.

In some examples, the packet manager 1225 may be configured as or otherwise support a means for receiving, from a first UE of the one or more first UEs, a first packet of a subset of the set of multiple source packets associated with the first network coding packet. In some examples, the feedback manager 1245 may be configured as or otherwise support a means for receiving an acknowledgment from a second UE for the first packet. In some examples, the feedback manager 1245 may be configured as or otherwise support a means for transmitting an acknowledgment to the first UE indicating that the second UE successfully received the first packet.

In some examples, the packet manager 1225 may be configured as or otherwise support a means for selecting the set of multiple source packets received from the one or more first UEs for retransmission based on failing to receive an acknowledgment for each of the set of multiple source packets from any other network coding device.

In some examples, the network coding manager 1235 may be configured as or otherwise support a means for transmitting an indication that the network coding device includes a complementary network coding device configured to assist with retransmitting the set of multiple source packets.

In some examples, the network coding manager 1235 may be configured as or otherwise support a means for computing each of the set of multiple network coding packets.

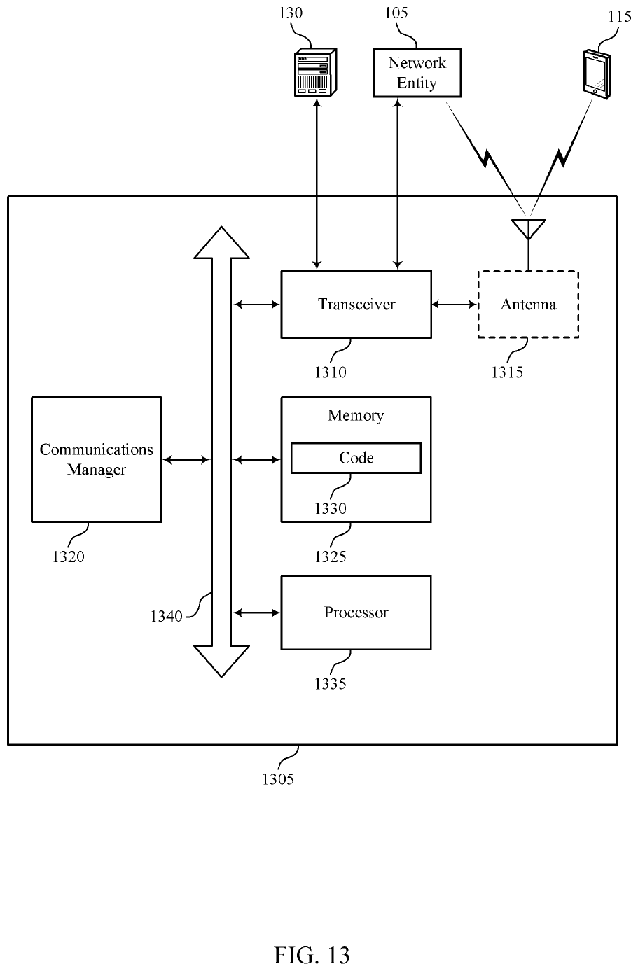

FIG. 13 shows a diagram of a system including a device 1305 that supports distributed network coding with complementary network coding devices in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (for example, operatively, communicatively, functionally, electronically, electrically) via one or more buses (for example, a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (for example, concurrently). The transceiver 1310 may also include a modem to modulate signals, to provide the modulated signals for transmission (for example, by one or more antennas 1315, by a wired transmitter), to receive modulated signals (for example, from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (for example, a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (for example, when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (for example, a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (for example, the memory 1325) to cause the device 1305 to perform various functions (for example, functions or tasks supporting distributed network coding with complementary network coding devices). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (for example, one or more physical nodes and supporting software such as operating systems, virtual machines, or container instances) that may host the functions (for example, by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (for example, within) a protocol layer of a protocol stack. In some examples, a bus 1340 may support communications associated with a logical channel of a protocol stack (for example, between protocol layers of a protocol stack), which may include communications performed within a component of the device 1305, or between different components of the device 1305 that may be co-located or located in different locations (for example, where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (for example, via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network coding device in accordance with examples as disclosed herein. For example, the communications manager 1320 may be configured as or otherwise support a means for receiving a set of multiple source packets from one or more first user equipment (UEs). The communications manager 1320 may be configured as or otherwise support a means for assigning a score to a first network coding packet of a set of multiple network coding packets, each network coding packet of the set of multiple network coding packets including one or more transport blocks from a different respective subset of source packets of the set of multiple source packets. The communications manager 1320 may be configured as or otherwise support a means for transmitting, to one or more second UEs, the first network coding packet based on the score satisfying a scoring threshold.

By including or configuring the communications manager 1320 in accordance with examples as described herein, the device 1305 may support techniques for reduced processing, reduced power consumption, and more efficient utilization of communication resources. Because the device 1305 may facilitate distributed network coding by efficiently selecting combinations of packets for network coding and enabling original transmitters of packets to manage retransmissions of the packets, overhead associated with retransmissions may be reduced while the likelihood that packets may be successfully received may increase. As such, processing and power consumption associated with retransmissions of the packet may be reduced and less resources may be used for the retransmissions.

In some examples, the communications manager 1320 may be configured to perform various operations (for example, receiving, obtaining, monitoring, outputting, transmitting) using or otherwise in cooperation with the transceiver 1310, the one or more antennas 1315 (for example, where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of distributed network coding with complementary network coding devices as described herein, or the processor 1335 and the memory 1325 may be otherwise configured to perform or support such operations.

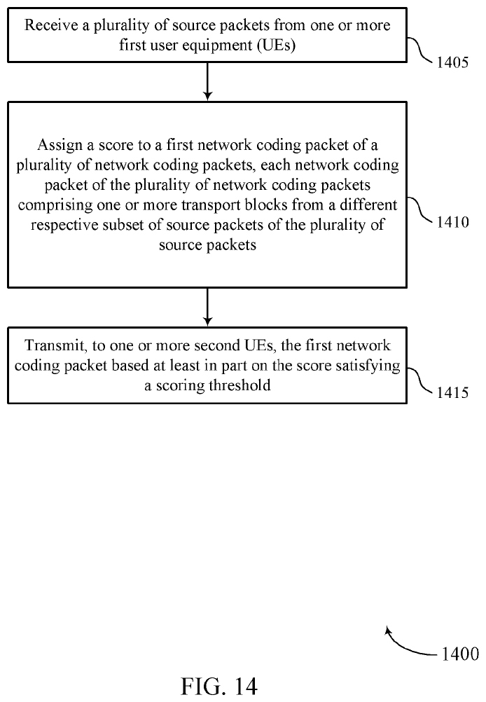

FIG. 14 shows a flowchart illustrating a method 1400 that supports distributed network coding with complementary network coding devices in accordance with one or more aspects of the present disclosure. The operations of the method 1400 may be implemented by a UE or a network entity or its components as described herein. For example, the operations of the method 1400 may be performed by a UE 115 as described with reference to FIGS. 1-9 or a network entity as described with reference to FIGS. 1-5 and 10-13. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include receiving a set of multiple source packets from one or more first user equipment (UEs). The operations of 1405 may be performed in accordance with examples as disclosed herein. In some examples, aspects of the operations of 1405 may be performed by a packet manager 825 or a packet manager 1225 as described with reference to FIGS. 8 and 12.

At 1410, the method may include assigning a score to a first network coding packet of a set of multiple network coding packets, each network coding packet of the set of multiple network coding packets including one or more transport blocks from a different respective subset of source packets of the set of multiple source packets. The operations of 1410 may be performed in accordance with examples as disclosed herein. In some examples, aspects of the operations of 1410 may be performed by a score manager 830 or a score manager 1230 as described with reference to FIGS. 8 and 12.

At 1415, the method may include transmitting, to one or more second UEs, the first network coding packet based on the score satisfying a scoring threshold. The operations of 1415 may be performed in accordance with examples as disclosed herein. In some examples, aspects of the operations of 1415 may be performed by a network coding manager 835 or a network coding manager 1235 as described with reference to FIGS. 8 and 12.

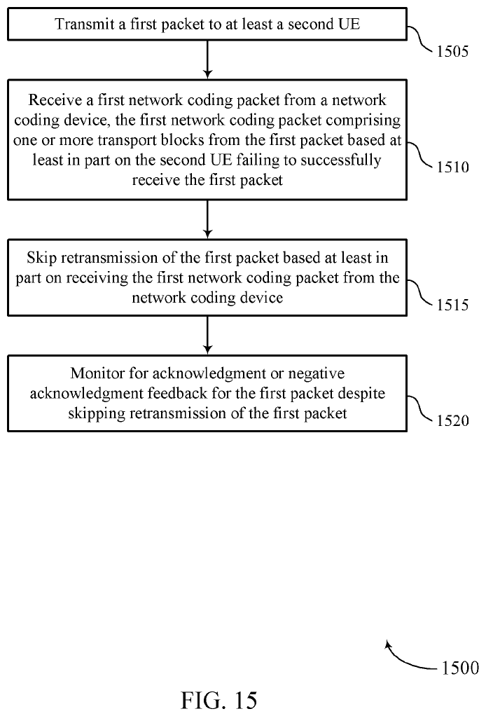

FIG. 15 shows a flowchart illustrating a method 1500 that supports distributed network coding with complementary network coding devices in accordance with one or more aspects of the present disclosure. The operations of the method 1500 may be implemented by a UE or its components as described herein. For example, the operations of the method 1500 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1505, the method may include transmitting a first packet to at least a second UE. The operations of 1505 may be performed in accordance with examples as disclosed herein. In some examples, aspects of the operations of 1505 may be performed by a packet manager 825 as described with reference to FIG. 8.

At 1510, the method may include receiving a first network coding packet from a network coding device, the first network coding packet including one or more transport blocks from the first packet based on the second UE failing to successfully receive the first packet. The operations of 1510 may be performed in accordance with examples as disclosed herein. In some examples, aspects of the operations of 1510 may be performed by a network coding manager 835 as described with reference to FIG. 8.

At 1515, the method may include skipping retransmission of the first packet based on receiving the first network coding packet from the network coding device. The operations of 1515 may be performed in accordance with examples as disclosed herein. In some examples, aspects of the operations of 1515 may be performed by a retransmission manager 840 as described with reference to FIG. 8.

At 1520, the method may include monitoring for acknowledgment or negative acknowledgment feedback for the first packet despite skipping retransmission of the first packet. The operations of 1520 may be performed in accordance with examples as disclosed herein. In some examples, aspects of the operations of 1520 may be performed by a feedback manager 845 as described with reference to FIG. 8.

The following provides an overview of aspects of the present disclosure:

Aspect 1: A method for wireless communication at a network coding device, comprising: receiving a plurality of source packets from one or more first user equipment (UEs); assigning a score to a first network coding packet of a plurality of network coding packets, each network coding packet of the plurality of network coding packets comprising one or more transport blocks from a different respective subset of source packets of the plurality of source packets; and transmitting, to one or more second UEs, the first network coding packet based at least in part on the score satisfying a scoring threshold.

Aspect 2: The method of aspect 1, further comprising: receiving an indication of the scoring threshold from a network entity, wherein the scoring threshold is based at least in part on one or more channel conditions.

Aspect 3: The method of any of aspects 1 through 2, further comprising: predicting a quantity of a subset of the plurality of source packets associated with the first network coding packet to be successfully received by the one or more second UEs, wherein assigning the score to the first network coding packet is based at least in part on the predicting.

Aspect 4: The method of aspect 3, further comprising: monitoring for acknowledgment feedback or negative acknowledgment feedback from each UE of the one or more second UEs, wherein the predicting is based at least in part on the monitoring.

Aspect 5: The method of any of aspects 1 through 4, further comprising: assigning respective scores to the plurality of network coding packets, wherein a subset of the scores assigned to a subset of the plurality of network coding packets satisfies the scoring threshold; and selecting the first network coding packet for transmission from the subset of the plurality of network coding packets.

Aspect 6: The method of aspect 5, wherein the first network coding packet is randomly selected from the subset of the plurality of network coding packets, or the first network coding packet is selected from the subset of the plurality of network coding packets based at least in part on the first network coding packet being assigned a highest score of the subset of scores assigned to the subset of the plurality of network coding packets.

Aspect 7: The method of any of aspects 1 through 6, further comprising: determining a maximum quantity of transmissions for a packet of a subset of the plurality of source packets associated with the first network coding packet, wherein the first network coding packet comprises one or more transport blocks from the packet based at least in part on a quantity of transmissions, by the network coding device, of the packet failing to exceed the maximum quantity of transmissions.

Aspect 8: The method of aspect 7, further comprising: receiving an indication of the maximum quantity of transmissions for the packet, wherein determining the maximum quantity of transmissions for the packet is based at least in part on receiving the indication of the maximum quantity of transmissions for the packet.

Aspect 9: The method of any of aspects 1 through 8, wherein the first network coding packet comprises an indication that each UE of a subset of the one or more first UEs associated with the first network coding packet is to transmit an acknowledgment to the network coding device after receiving the first network coding packet.

Aspect 10: The method of aspect 9, further comprising: receiving the acknowledgment from each UE of the subset of the one or more first UEs based at least in part on the first network coding packet comprising the indication; and avoiding transmitting acknowledgment or negative acknowledgment feedback to the subset of the one or more first UEs based at least in part on receiving the acknowledgment from each UE of the subset of the one or more first UEs.

Aspect 11: The method of any of aspects 1 through 10, further comprising: receiving, from a first UE of the one or more first UEs, a first packet of a subset of the plurality of source packets associated with the first network coding packet; receiving an acknowledgment from a second UE for the first packet; and transmitting an acknowledgment to the first UE indicating that the second UE successfully received the first packet.

Aspect 12: The method of any of aspects 1 through 11, further comprising: selecting the plurality of source packets received from the one or more first UEs for retransmission based at least in part on failing to receive an acknowledgment for each of the plurality of source packets from any other network coding device.

Aspect 13: The method of any of aspects 1 through 12, further comprising: transmitting an indication that the network coding device comprises a complementary network coding device configured to assist with retransmitting the plurality of source packets.

Aspect 14: The method of any of aspects 1 through 13, further comprising: computing each of the plurality of network coding packets.

Aspect 15: A method for wireless communication at a first UE, comprising: transmitting a first packet to at least a second UE; receiving a first network coding packet from a network coding device, the first network coding packet comprising one or more transport blocks from the first packet based at least in part on the second UE failing to successfully receive the first packet; skipping retransmission of the first packet based at least in part on receiving the first network coding packet from the network coding device; and monitoring for acknowledgment or negative acknowledgment feedback for the first packet despite skipping retransmission of the first packet.

Aspect 16: The method of aspect 15, further comprising: updating a hybrid automatic repeat request identifier for the first packet based at least in part on receiving the first network coding packet from the network coding device.

Aspect 17: The method of any of aspects 15 through 16, wherein the first network coding packet comprises an indication that the first UE is to transmit an acknowledgment to the network coding device after receiving the first network coding packet, the method further comprising: transmitting the acknowledgment to the network coding device based at least in part on the first network coding packet comprising the indication.

Aspect 18: The method of any of aspects 15 through 17, further comprising: monitoring for an acknowledgment or a negative acknowledgment from the second UE for the first packet based at least in part on receiving the first network coding packet.

Aspect 19: The method of aspect 18, further comprising: determining a first resource to monitor for the acknowledgment or negative acknowledgment from the second UE based at least in part on a second resource on which the first network coding packet is received, an identifier of the first packet or the first network coding packet, or a combination thereof.

Aspect 20: The method of aspect 19, further comprising: receiving, from the network coding device or a network entity, an indication of how to determine the first resource, wherein determining the first resource is based at least in part on the indication of how to determine the first resource.

Aspect 21: The method of any of aspects 15 through 20, further comprising: receiving, from the network coding device, an acknowledgment indicating that the second UE successfully received the first packet.

Aspect 22: The method of any of aspects 15 through 21, further comprising: selecting the network coding device to retransmit the first packet based at least in part on one or more criteria, the one or more criteria comprising a buffer of the network coding device, a remaining power of the network coding device, location information associated with the network coding device, or a combination thereof.

Aspect 23: The method of aspect 22, further comprising: receiving an indication of the one or more criteria from a network entity, wherein selecting the network coding device to retransmit the first packet is based at least in part on receiving the indication of the one or more criteria.

Aspect 24: The method of any of aspects 15 through 23, further comprising: receiving an indication that the network coding device comprises a complementary network coding device configured to assist with retransmitting the first packet, wherein the monitoring for the acknowledgment or negative acknowledgment feedback for the first packet is based at least in part on the network coding device comprising the complementary network coding device.

Aspect 25: An apparatus for wireless communication at a network coding device, comprising a processor; memory coupled with the processor; and instructions stored in the memory and executable by the processor to cause the apparatus to perform a method of any of aspects 1 through 14.

Aspect 26: An apparatus for wireless communication at a network coding device, comprising at least one means for performing a method of any of aspects 1 through 14.

Aspect 27: A non-transitory computer-readable medium storing code for wireless communication at a network coding device, the code comprising instructions executable by a processor to perform a method of any of aspects 1 through 14.

Aspect 28: An apparatus for wireless communication at a first UE, comprising a processor; memory coupled with the processor; and instructions stored in the memory and executable by the processor to cause the apparatus to perform a method of any of aspects 15 through 24.

Aspect 29: An apparatus for wireless communication at a first UE, comprising at least one means for performing a method of any of aspects 15 through 24.

Aspect 30: A non-transitory computer-readable medium storing code for wireless communication at a first UE, the code comprising instructions executable by a processor to perform a method of any of aspects 15 through 24.

It should be noted that the methods described herein describe possible implementations, and that the operations and the features may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of conditions. For example, an example feature that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (for example, receiving information), accessing (for example, accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a network coding device, comprising:
receiving a plurality of source packets from one or more first user equipment (UEs);
assigning a score to a first network coding packet of a plurality of network coding packets, each network coding packet of the plurality of network coding packets comprising one or more transport blocks from a different respective subset of source packets of the plurality of source packets; and
transmitting, to one or more second UEs, the first network coding packet based at least in part on the score satisfying a scoring threshold.

2. The method of claim 1, further comprising receiving an indication of the scoring threshold from a network entity, wherein the scoring threshold is based at least in part on one or more channel conditions.

3. The method of claim 1, further comprising predicting a quantity of a subset of the plurality of source packets associated with the first network coding packet to be successfully received by the one or more second UEs, wherein assigning the score to the first network coding packet is based at least in part on the predicting.

4. The method of claim 3, further comprising monitoring for acknowledgment feedback or negative acknowledgment feedback from each UE of the one or more second UEs, wherein the predicting is based at least in part on the monitoring.

5. The method of claim 1. further comprising:
assigning respective scores to the plurality of network coding packets, wherein a subset of the scores assigned to a subset of the plurality of network coding packets satisfies the scoring threshold; and
selecting the first network coding packet for transmission from the subset of the plurality of network coding packets.

6. The method of claim 5, wherein the first network coding packet is randomly selected from the subset of the plurality of network coding packets, or the first network coding packet is selected from the subset of the plurality of network coding packets based at least in part on the first network coding packet being assigned a highest score of the subset of scores assigned to the subset of the plurality of network coding packets.

7. The method of claim 1, further comprising determining a maximum quantity of transmissions for a packet of a subset of the plurality of source packets associated with the first network coding packet, wherein the first network coding packet comprises one or more transport blocks from the packet based at least in part on a quantity of transmissions, by the network coding device, of the packet failing to exceed the maximum quantity of transmissions.

8. The method of claim 7, further comprising receiving an indication of the maximum quantity of transmissions for the packet, wherein determining the maximum quantity of transmissions for the packet is based at least in part on receiving the indication of the maximum quantity of transmissions for the packet.

9. The method of claim 1, wherein the first network coding packet comprises an indication that each UE of a subset of the one or more first UEs associated with the first network coding packet is to transmit an acknowledgment to the network coding device after receiving the first network coding packet.

10. The method of claim 9, further comprising:
receiving the acknowledgment from each UE of the subset of the one or more first UEs based at least in part on the first network coding packet comprising the indication; and
avoiding transmitting acknowledgment or negative acknowledgment feedback to the subset of the one or more first UEs based at least in part on receiving the acknowledgment from each UE of the subset of the one or more first UEs.

11. The method of claim 1, further comprising:
receiving, from a first UE of the one or more first UEs, a first packet of a subset of the plurality of source packets associated with the first network coding packet;
receiving an acknowledgment from a second UE for the first packet; and
transmitting an acknowledgment to the first UE indicating that the second UE successfully received the first packet.

12. The method of claim 1, further comprising selecting the plurality of source packets received from the one or more first UEs for retransmission based at least in part on failing to receive an acknowledgment for each of the plurality of source packets from any other network coding device.

13. The method of claim 1, further comprising transmitting an indication that the network coding device comprises a complementary network coding device configured to assist with retransmitting the plurality of source packets.

14. The method of claim 1, further comprising computing each of the plurality of network coding packets.

15. A method for wireless communication at a first user equipment (UE), comprising:
transmitting a first packet to at least a second UE;
receiving a first network coding packet from a network coding device, the first network coding packet comprising one or more transport blocks from the first packet based at least in part on the second UE failing to successfully receive the first packet;
skipping retransmission of the first packet based at least in part on receiving the first network coding packet from the network coding device; and
monitoring for acknowledgment or negative acknowledgment feedback for the first packet despite skipping retransmission of the first packet.

16. The method of claim 15, further comprising updating a hybrid automatic repeat request identifier for the first packet based at least in part on receiving the first network coding packet from the network coding device.

17. The method of claim 15, wherein the first network coding packet comprises an indication that the first UE is to transmit an acknowledgment to the network coding device after receiving the first network coding packet, the method further comprising transmitting the acknowledgment to the network coding device based at least in part on the first network coding packet comprising the indication.

18. The method of claim 15, further comprising monitoring for an acknowledgment or a negative acknowledgment from the second UE for the first packet based at least in part on receiving the first network coding packet.

19. The method of claim 18, further comprising determining a first resource to monitor for the acknowledgment or negative acknowledgment from the second UE based at least in part on a second resource on which the first network coding packet is received, an identifier of the first packet or the first network coding packet, or a combination thereof.

20. The method of claim 19, further comprising receiving, from the network coding device or a network entity, an indication of how to determine the first resource, wherein determining the first resource is based at least in part on the indication of how to determine the first resource.

21. The method of claim 15, further comprising receiving, from the network coding device, an acknowledgment indicating that the second UE successfully received the first packet.

22. The method of claim 15, further comprising selecting the network coding device to retransmit the first packet based at least in part on one or more criteria, the one or more criteria comprising a buffer of the network coding device, a remaining power of the network coding device, location information associated with the network coding device, or a combination thereof.

23. The method of claim 22, further comprising receiving an indication of the one or more criteria from a network entity, wherein selecting the network coding device to retransmit the first packet is based at least in part on receiving the indication of the one or more criteria.

24. The method of claim 15, further comprising receiving an indication that the network coding device comprises a complementary network coding device configured to assist with retransmitting the first packet, wherein the monitoring for the acknowledgment or negative acknowledgment feedback for the first packet is based at least in part on the network coding device comprising the complementary network coding device.

25. An apparatus for wireless communication at a network coding device, comprising:
a processor; and
memory coupled with the processor and storing instructions executable by the processor to cause the apparatus to:
receive a plurality of source packets from one or more first user equipment (UEs);
assign a score to a first network coding packet of a plurality of network coding packets, each network coding packet of the plurality of network coding packets comprising one or more transport blocks from a different respective subset of source packets of the plurality of source packets; and
transmit, to one or more second UEs, the first network coding packet based at least in part on the score satisfying a scoring threshold.

26. The apparatus of claim 25, wherein the instructions are further executable by the processor to cause the apparatus to receive an indication of the scoring threshold from a network entity, wherein the scoring threshold is based at least in part on one or more channel conditions.

27. The apparatus of claim 25, wherein the instructions are further executable by the processor to cause the apparatus to predict a quantity of a subset of the plurality of source packets associated with the first network coding packet to be successfully received by the one or more second UEs, wherein assigning the score to the first network coding packet is based at least in part on the predicting.

28. An apparatus for wireless communication at a first user equipment (UE), comprising:
a processor; and
memory coupled with the processor and storing instructions executable by the processor to cause the apparatus to:
transmit a first packet to at least a second UE;
receive a first network coding packet from a network coding device, the first network coding packet comprising one or more transport blocks from the first packet based at least in part on the second UE failing to successfully receive the first packet;
skip retransmission of the first packet based at least in part on receiving the first network coding packet from the network coding device; and
monitor for acknowledgment or negative acknowledgment feedback for the first packet despite skipping retransmission of the first packet.

29. The apparatus of claim 28, wherein the instructions are further executable by the processor to cause the apparatus to update a hybrid automatic repeat request identifier for the first packet based at least in part on receiving the first network coding packet from the network coding device.

30. The apparatus of claim 28, wherein the first network coding packet comprises an indication that the first UE is to transmit an acknowledgment to the network coding device after receiving the first network coding packet, and the instructions are further executable by the processor to cause the apparatus to:
transmit the acknowledgment to the network coding device based at least in part on the first network coding packet comprising the indication.
